(19) United States
(12) Patent Application Publication
(10) Pub. No.: US 2025/0360728 A1
(43) Pub. Date: Nov. 27, 2025

(54) PRINTING APPARATUS

(71) Applicant: CANON KABUSHIKI KAISHA, Tokyo (JP)

(72) Inventors: ITARU WADA, Kanagawa (JP); SHOICHI ZENSAI, Kanagawa (JP); TOMOHIRO SUZUKI, Tokyo (JP)

(21) Appl. No.: 19/211,021

(22) Filed: May 16, 2025

(30) Foreign Application Priority Data
May 21, 2024 (JP) 2024-082896

(51) Int. Cl. B41J 11/00; B41J 11/04; B41J 29/02

(52) U.S. Cl. CPC B41J 11/00222; B41J 11/04; B41J 29/02

(57) ABSTRACT

A printing apparatus configured to dry a liquid composition applied to a print medium while conveying the print medium between a plurality of casings, wherein a blowing mechanism for blowing air to the print medium is disposed in at least one of the plurality of casings, and, between a first casing in which a first blowing mechanism serving as the blowing mechanism is disposed and a second casing adjacent to the first casing, a connection member for connecting a blowing space in the first blowing mechanism of the first casing and a conveyance space in the second casing in which space the print medium is conveyed, thereby forming a closed space, is disposed.

### BACKGROUND

### Field of the Technology

The present disclosure relates to a printing apparatus including a drying unit that dries a liquid composition applied to a print medium.

### Description of the Related Art

Conventionally, in the field of printing apparatuses that perform printing by an inkjet method, there is known a printing apparatus including a printing unit that applies a liquid composition onto a print medium to form an image, and a drying unit that dries the applied liquid composition to fix the liquid composition to the print medium.

Japanese Patent No. 5600444 discloses a printing apparatus including drying units. In the printing apparatus described in Japanese Patent No. 5600444, drying units are respectively disposed on a plurality of casing frames, and air heated by a heating device is fed to the drying units. Specifically, from a warm air feed port formed on the upper surface of each casing, warm air is blown toward the print medium in a vertical direction to dry the liquid applied to the print medium.

Japanese Patent No. 5043980 discloses a print apparatus including a drying unit that causes hot air heated by a heater to circulate, and blows the hot air to a sheet to dry the ink on the sheet.

However, the technique disclosed in Japanese Patent No. 5600444 may cause the hot air to leak out from the space between the casing frame including the drying unit and the casing frame located adjacent thereto, and the leakage of the air may lead to a reduction in drying efficiency.

In addition, in Japanese Patent No. 5043980, consideration has not been given to respectively place drying units on the plurality of casing frames.

### SUMMARY

The present disclosure has been made in view of the above-described problems, and improves drying efficiency in a printing apparatus including drying units disposed in a plurality of casings.

According to some embodiments, a printing apparatus configured to dry a liquid composition applied to a print medium while conveying the print medium between a plurality of casings, wherein a blowing mechanism for blowing air to the print medium is disposed in at least one of the plurality of casings, and, between a first casing in which a first blowing mechanism serving as the blowing mechanism is disposed and a second casing adjacent to the first casing, a connection member for connecting a blowing space in the first blowing mechanism of the first casing and a conveyance space in the second casing in which space the print medium is conveyed, thereby forming a closed space, is disposed.

Further features of the present disclosure will become apparent from the following description of exemplary embodiments with reference to the attached drawings.

### BRIEF DESCRIPTION OF THE DRAWINGS

FIG. 1 is a schematic cross-sectional view showing an internal configuration of a printing apparatus according to a first embodiment of the present disclosure.

FIG. 2 is a perspective view of a sheet conveyance unit casing of a printing unit.

FIG. 3 is a perspective view of an elevation mechanism of a printhead.

FIGS. 4A and 4B are cross-sectional views showing exemplary configurations of a drying unit.

FIG. 5 is a schematic plan view showing an exemplary configuration of an airflow space of the drying unit.

FIG. 6 is a cross-sectional view showing an exemplary configuration of an airflow duct of a cooling unit.

FIG. 7 is a schematic diagram showing a configuration for a first printing step.

FIG. 8 is a schematic diagram showing a relative positional relationship between configurations for the first printing step and a second printing step.

FIG. 9 is a block diagram of a control unit.

FIG. 10 is a schematic diagram showing an internal configuration of a printing apparatus composed of a plurality of casing frames.

FIG. 11 is a cross-sectional view showing a configuration of an airflow sealing member disposed between drying units.

FIGS. 12A to 12D are perspective views of airflow sealing members.

FIG. 13 is a cross-sectional view showing a configuration of an airflow sealing member disposed between the drying unit and the cooling unit.

FIG. 14 is a perspective view showing a state in which covers of casing frames are open.

FIGS. 15A and 15B are perspective views showing a configuration of a drying unit according to a second embodiment.

FIGS. 16A to 16C are a perspective view and cross-sectional views showing an internal configuration of the drying unit according to the second embodiment.

FIGS. 17A to 17C are cross-sectional views showing a process of drawing an accommodation unit of the drying unit according to the second embodiment.

FIGS. 18A to 18D are perspective views showing an electrical connection unit of the drying unit according to the second embodiment.

FIGS. 19A and 19B are perspective views showing an exhaust unit of the drying unit according to the second embodiment.

FIGS. 20A to 20C are perspective views showing a maintenance method of the exhaust unit of the drying unit according to the second embodiment.

FIGS. 21A to 21D are perspective views showing a configuration of an exhaust fan according to the second embodiment.

FIGS. 22A to 22C are side views showing a method for removing the exhaust fan according to the second embodiment.

FIGS. 23A to 23D are cross-sectional views showing a configuration of a drying unit according to a third embodiment.

### DESCRIPTION OF THE EMBODIMENTS

Hereinafter, various exemplary embodiments, features, and aspects will be described in detail with reference to the attached drawings. Note, the following embodiments are not intended to limit the scope of the claimed invention. Multiple features are described in the embodiments, but limitation is not made to a configuration that uses all such features, and multiple such features may be combined as appropriate. Furthermore, in the attached drawings, the same reference numerals are given to the same or similar configurations, and redundant description thereof is omitted.

### First Embodiment

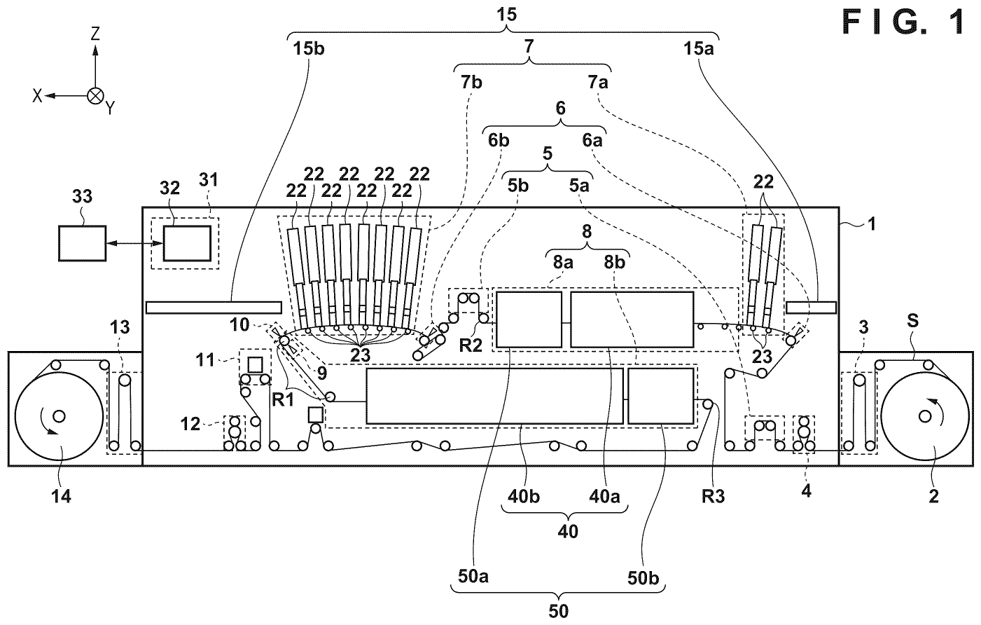

First, as coordinate axes, a direction upward (Z direction) of the apparatus in FIG. 1 is defined as an upward direction, a direction from the right to left of the apparatus as the longitudinal direction (X direction), a direction from the front to back of a paper surface perpendicular to a sheet conveyance direction (X direction) as a sheet width direction (Y direction).

The present embodiment will be described taking, as an example, a printer that uses a continuous sheet wound in a roll as a print medium, and is equipped with a so-called line head, which is a printhead having an ejection port region corresponding to the width of paper. However, the present disclosure is also applicable to a printer that uses a sheet-fed print medium, and to a printer equipped with a serial head that moves a carriage equipped with a printhead along a direction intersecting the conveyance direction of the print medium, thereby printing an image on the print medium. The print medium is not limited to paper, and various materials that can be subjected to print processing may be used.

### Printing Apparatus

FIG. 1 is a schematic cross-sectional view showing an internal configuration of a printing apparatus 1. Inside the printing apparatus 1 according to the present embodiment, various units, namely, an unwinding roll unit 2, a first dancer unit 3, a first main conveyance unit 4, a meandering correction unit 5, a conveyance detection unit 6, a printing unit 7, a conveyance tension detection unit 9, a printed image position detection unit 10, a scanner unit 11, a second main conveyance unit 12, a second dancer unit 13, a winding roll unit 14, a maintenance unit 15, a drying unit 40, and a cooling unit 50 are disposed. A continuous sheet S serving as a print medium is conveyed along a sheet conveyance path indicated by the solid line in the drawing, and is processed by the various units.

In the printing apparatus 1 according to the present embodiment, a first printing step and a second printing step are performed along the sheet conveyance path (sheet S). In the first printing step, an image is printed on the sheet S through the processing performed by a first printing unit 7a, a first drying unit 40a, and a first cooling unit 50a. In the second printing step, through the processing performed by a second printing unit 7b, a second drying unit 40b, and a second cooling unit 50b, an image is printed on the sheet S that has been subjected to the first printing step. In this manner, the printing apparatus 1 can continuously print an image on the sheet S by subjecting the sheet S to the first printing step and the second printing step described above. The printing apparatus 1 can also alternatively select the above-described printing steps according to the printing conditions. In that case, an image is printed on the sheet S by the selected printing step alone. Note that an operation in which the sheet S is conveyed from the unwinding roll unit 2 toward the winding roll unit 14 is defined as a forward direction conveyance, and an operation in which the sheet S is conveyed in the opposite direction is defined as a backward direction conveyance.

The unwinding roll unit 2 is a unit for holding and supplying a continuous sheet wound in a roll. The unwinding roll unit 2 is configured to accommodate an unwinding roll, and draw out and supply the sheet S. The number of rolls that can be accommodated is not limited to one, and two, or three or more rolls may be accommodated, and the sheet S may be alternately drawn from the rolls, and fed. The unwinding roll unit 2 is configured to be independently rotated forward and backward by a drive motor (not shown).

The first dancer unit 3 is a unit for applying a predetermined tension to the sheet S between the unwinding roll unit 2 and the first main conveyance unit 4. The first dancer unit 3 uses a tension application unit (not shown) to apply the tension to the sheet S.

The first main conveyance unit 4 is a unit for feeding the sheet S into the units provided along the sheet conveyance path (sheet S), and applying a tension to the sheet S between the second main conveyance unit 12 and itself. The first main conveyance unit 4 is rotated by the driving of a motor (not shown), and performs conveyance while applying a tension to the sheet S.

The meandering correction unit 5 is a unit for correcting the meandering of the sheet in the width direction when conveying the sheet S while applying a tension thereto. In the present embodiment, the meandering correction unit 5 includes a first meandering correction unit 5a and a second meandering correction unit 5b that are disposed upstream of the respective printing steps in the sheet conveyance path. The meandering correction unit 5 includes a meandering correction roller, and a meandering detection sensor (not shown) that detects the meandering of the sheet S. The meandering correction roller is driven by a motor (not shown), can change the inclination of the sheet S, and corrects the meandering of the sheet S based on the measurement performed by the meandering detection sensor. By causing the sheet S to be wound around the meandering correction roller, the function of the meandering correction roller is enhanced.

The conveyance detection unit 6 is a unit for detecting the conveyance speed of the sheet S and a mark printed in advance on the sheet S in order to control the image forming timing of the printing unit 7. In the present embodiment, the conveyance detection unit 6 includes a first conveyance detection unit 6a and a second conveyance detection unit 6b that are disposed upstream of the respective printing steps of the sheet conveyance path. The first conveyance detection unit 6a and the second conveyance detection unit 6b are used to control the image forming timing of the first printing unit 7a and the second printing unit 7b, respectively.

The printing unit 7 is a processing unit that applies, to the sheet S being conveyed, a liquid composition (ink) from above using printheads 22, to form an image thereon. A conveyance path in the printing unit 7 is formed by guide rollers 23 arranged in an upwardly protruding arc shape, and a predetermined tension is applied to the sheet S to secure clearances between the sheet S and the printheads 22. A plurality of printheads 22 are arranged side by side in the conveyance direction. In the present embodiment, the first printing unit 7a includes a total of two line-type printheads, namely, a head corresponding to white (W) ink and a head corresponding to a reaction liquid. The second printing unit 7b includes four line-type printheads respectively corresponding to four colors, namely, black (Bk), yellow (Y), magenta (M), and cyan (C). In addition, the second printing unit 7b includes four line-type printheads, namely a line-type printhead corresponding to the reaction liquid, and line-type printheads respectively corresponding to three spot color inks, namely, orange (O), green (G), and violet (V). That is, the second printing unit 7b includes a total of eight line-type printheads. The types and the number of colors and the number of printheads 22 are not limited to the above examples.

Here, a reaction liquid refers to a liquid containing a component that causes an increase in the viscosity of an ink. Here, an increase in the viscosity of an ink refers to a state in which a color material, a resin, or the like constituting the ink comes into contact with the component that causes an increase in the viscosity of the ink, and thus chemically reacts with or is physically adsorbed to the component, thereby exhibiting a rise in the viscosity of the ink. An increase in the viscosity of an ink is not limited to an increase in the overall viscosity of an ink, and includes a local viscosity rise due to partial aggregation of a component, such as a color material or a resin, constituting the ink. As the component that causes an increase in the viscosity of an ink, multivalent metal ions, a cationic resin, an organic acid, or the like can be used. By applying the reaction liquid to the sheet S before applying an ink thereto, the ink that has reached the sheet S can be immediately fixed. This makes it possible to suppress bleeding, which is mixing of adjacent inks. As the inkjet method, a method using heating elements, a method using piezoelectric elements, a method using electrostatic elements, a method using micro-electro-mechanical systems (MEMS) elements, or the like can be used. The inks are fed to the printheads 22 from respective ink tanks (not shown) via respective ink tubes.

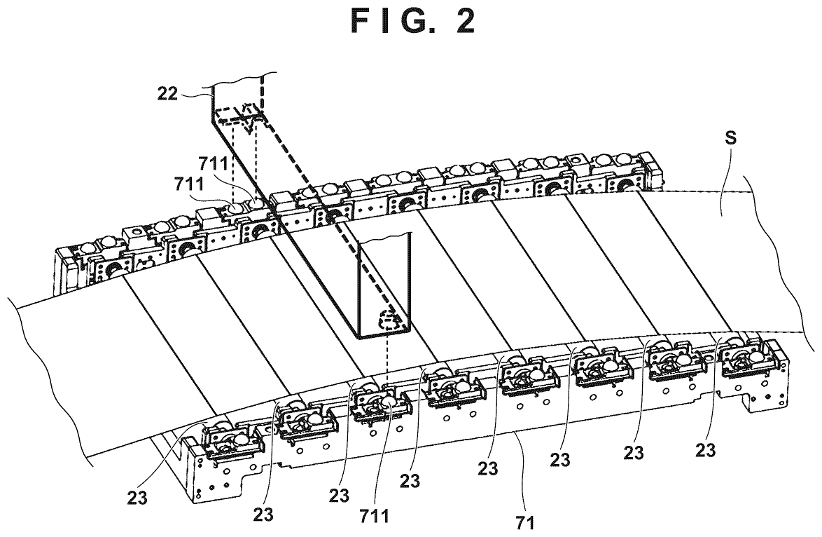

As shown in FIG. 2, a sheet conveyance unit casing 71 of the printing unit 7 includes a plurality of positioning members 711 for positioning the printheads 22. The positioning members 711 are disposed on opposite sides of the sheet S in the width direction with the sheet S interposed therebetween. In FIG. 2, one printhead 22 is provided with one positioning members 711 on the front side and two positioning members 711 on the back side.

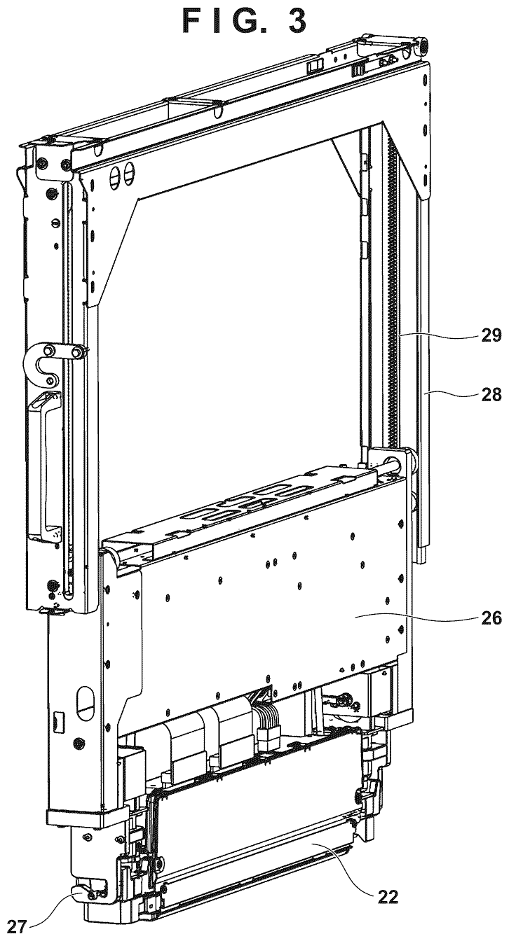

As shown in FIG. 3, each printhead 22 is pivotably supported by a support shaft 27 thereof being supported from below by a printhead holding unit 26 for moving the printhead 22 up and down. The printhead holding unit 26 is operated, by a drive mechanism (not shown) contained therein, so as to be moved up and down along an elevation rails 29 provided inside a printhead elevation frame 28. In the present embodiment, the liquid composition is applied onto the sheet S using inkjet heads. However, the method for applying the liquid composition onto the sheet using the printing unit 7 is not limited thereto. In the present embodiment, the reaction liquid is applied using the printheads 22. However, the reaction liquid may be applied using a roller, a die coating device (die coater), a blade coating device (blade coater), or the like.

The conveyance tension detection unit 9 is a unit for detecting a tension when the sheet S is conveyed between the first main conveyance unit 4 and the second main conveyance unit 12, while applying a tension to the sheet S.

The printed image position detection unit 10 is a unit for detecting misalignment of the image formed on the sheet S by the printing unit 7 during printing, and correcting the printing.

Winding guide rollers R1 are rollers on each of which a surface of the sheet S that is opposite to the ink-applied surface thereof is wound at a predetermined winding angle at a position downstream of the second printing unit 7b in the conveyance direction. In the present embodiment, two winding guide rollers R1 are disposed between the second printing unit 7b and the second drying unit 40b. The sheet S is folded back by the winding guide rollers R1 such that a portion thereof on the upper side of the apparatus and a portion thereof on the lower side of the apparatus are substantially parallel to each other, and the second drying unit 40b is disposed downward of the apparatus relative to the printing unit 7b.

The drying unit 40 (first drying unit 40a, second drying unit 40b) is a unit that reduces a liquid component contained in the liquid composition applied to the sheet S by the printing unit 7, and enhancing the fixation between the sheet S and the ink. The drying unit 40 blows air to the printed sheet S to dry the applied ink. Inside the drying unit 40, air is blown at least from the ink-applied surface side onto the sheet S passing therethrough, to dry the ink-applied surface of the sheet S. As the drying method, in addition to the method that blows air, a method that irradiates the surface of the sheet S with electromagnetic waves (e.g., ultraviolet rays or infrared rays), or a conduction heat transfer method based on contact with a heating member may be used, or these methods may be combined.

The cooling unit 50 (first cooling unit 50a, second cooling unit 50b) has the function of cooling the sheet S fixed by the drying unit 40 to solidify the softened ink, and also has the function of suppressing an amount of temperature change of the sheet S in a downstream step in the printing apparatus. Inside the cooling unit 50, air (cool air) at a temperature lower than that of the sheet S is blown at least from the ink-applied surface side to the sheet S passing through the cooling unit 50, to cool the ink-applied surface of the sheet S. The cooling method is not limited to a method that supplies air, and a conduction heat transfer method based on contact with a heat dissipation member, or these methods may be combined. To increase the cooling efficiency, air may be blown to both surfaces of the sheet S.

The scanner unit 11 is a unit for reading a test image formed on the sheet S by the printing unit 7 prior to the actual printing, detecting the misalignment and density of the image, and correcting the actual printing.

The second main conveyance unit 12 is a unit that conveys the sheet S between the first main conveyance unit 4 and itself while applying a tension thereto, and adjusts the tension of the sheet S. The second main conveyance unit 12 includes a roller driven by a motor (not shown), and controls the rotation speed of the roller inside the second main conveyance unit 12 according to the value of the tension detected by the conveyance tension detection unit 9. As a configuration for adjusting the tension of the sheet S, a configuration in which the tension of the sheet S is adjusted by a drivingly coupled clutch (not shown) that can control the torque may be added. In this case, as the tension control method, two possible methods may include: a torque control method in which the value of a torque transmitted from the clutch is controlled, and a speed control method in which the speed of the roller of the second main conveyance unit 12 is controlled. Depending on the purpose, these tension control methods may be switched for use, or may be used concurrently.

The second dancer unit 13 is a unit for applying a predetermined tension to the sheet S between the second main conveyance unit 12 and the winding roll unit 14. The second dancer unit 13 uses a tension application unit (not shown) to apply the tension to the sheet S.

The winding roll unit 14 is a unit for winding up, around a roll core, the sheet S that has been subjected to the print processing. The number of rolls that can be collected is not limited to one. It is possible to adopt a configuration in which two, or three or more roll cores are provided, and the rolls may be alternatively switched to collect the sheet S. The winding roll unit 14 is configured to be independently rotated forward and backward by a drive motor (not shown). By controlling the respective drive motors of the unwinding roll unit 2 and the winding roll unit 14 to be rotated forward or backward, the sheet S can be subjected to the forward direction conveyance or the backward direction conveyance. In the case of the backward direction conveyance as well, the sheet S is conveyed between the first main conveyance unit 4 and the second main conveyance unit 12 while a tension is applied to the sheet S as in the case of the forward direction conveyance. Depending on the content of the post-printing process, a configuration in which a continuous sheet is cut with a cutter, and the cut sheets S are stacked may be adopted in place of the configuration in which the sheet S is wound around the roll core.

The control unit 31 is a unit responsible for control of the units of the entire printing apparatus. The control unit 31 includes a CPU, a storage device storing various types of information such as the ejection speed and the thickness of the print medium, a controller including various types of control units, an external interface, and an operation unit 32 via which a user performs input and output. The operations of the printing apparatus 1 are controlled based on instructions from a controller or a host apparatus 33 such as a host computer connected to the controller via an external interface.

The maintenance unit 15 is a unit including a mechanism for restoring the ejection performance of the printheads 22. Examples of such a mechanism include a cap mechanism for protecting the ink ejection surfaces of the printheads 22, a wiper mechanism for wiping the ink ejection surfaces, and a suction mechanism for sucking the inks in the printheads 22 from the ink ejection surfaces under a negative pressure. In addition, the maintenance unit 15 includes a drive mechanism and rails (not shown), and can be reciprocated in a horizontal direction along the rails. At the time of maintenance of a printhead 22, the maintenance unit 15 is moved to a location directly below the printhead 22, and is moved to a position retracted from the location directly below the printhead 22 when a maintenance operation is not performed. In the present embodiment, a first maintenance unit 15a and a second maintenance unit 15b respectively corresponding to the first printing unit 7a and the second printing unit 7b are provided.

### Configuration of Drying Unit 40

Next, the configuration of the above-described drying unit 40 (first drying unit 40a, second drying unit 40b) in which air is blown to the sheet S will be described in further detail.

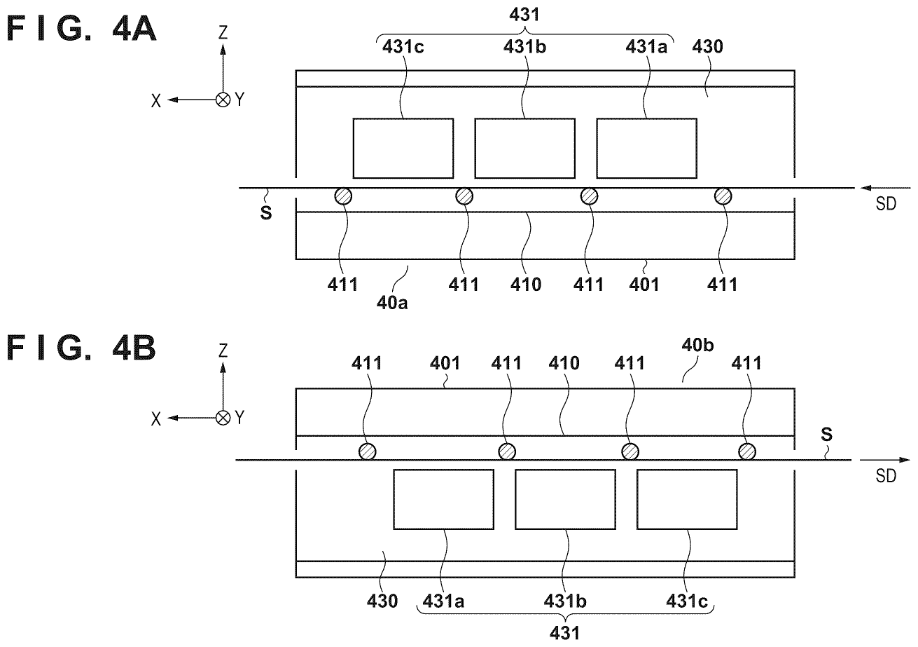

FIG. 4 shows cross-sectional views of the sheet S as viewed from the side in the conveyance direction, showing an internal structure of the drying unit 40. FIG. 4A shows an internal configuration of the first drying unit 40a, and FIG. 4B shows an internal configuration of the second drying unit 40b.

In FIG. 4, the sheet conveyance direction is defined as an SD direction, the sheet width direction as a Y direction, and the direction from the right to left of the apparatus as an X direction, and the direction from the bottom to top of the apparatus as a Z direction. The drying unit 40 includes a casing 401, and the casing 401 is provided with a sheet support unit 410 having sheet support rollers 411 disposed at positions in contact with the conveyed sheet S, and an airflow space 430.

The sheet support unit 410 limits the displacement of the sheet S in the Z direction using the sheet support rollers 411. In the first drying unit 40a, a clearance is provided in a +Z direction from the sheet S that is conveyed facing the sheet support unit 410, whereby the airflow space 430 is formed. In the second drying unit 40b, a clearance is provided in the −Z direction from the sheet S that is conveyed facing the sheet support unit 410, whereby the airflow space 430 is formed.

The airflow space in the present embodiment is formed by one or more airflow ducts disposed in one airflow space 430. In the present embodiment, three airflow ducts 431a to 431c are installed in the airflow space 430. In the present embodiment, a plurality of drying units 40 are provided side by side in the SD direction serving as the sheet conveyance direction according to the desired productivity (the conveyance speed of the sheet S). Note that the numbers of airflow spaces 430 and airflow ducts 431, as well as casings 401 are not limited. The detailed configuration of the internal configuration of the first drying unit 40a will be described later.

### Configuration of Airflow Space 430

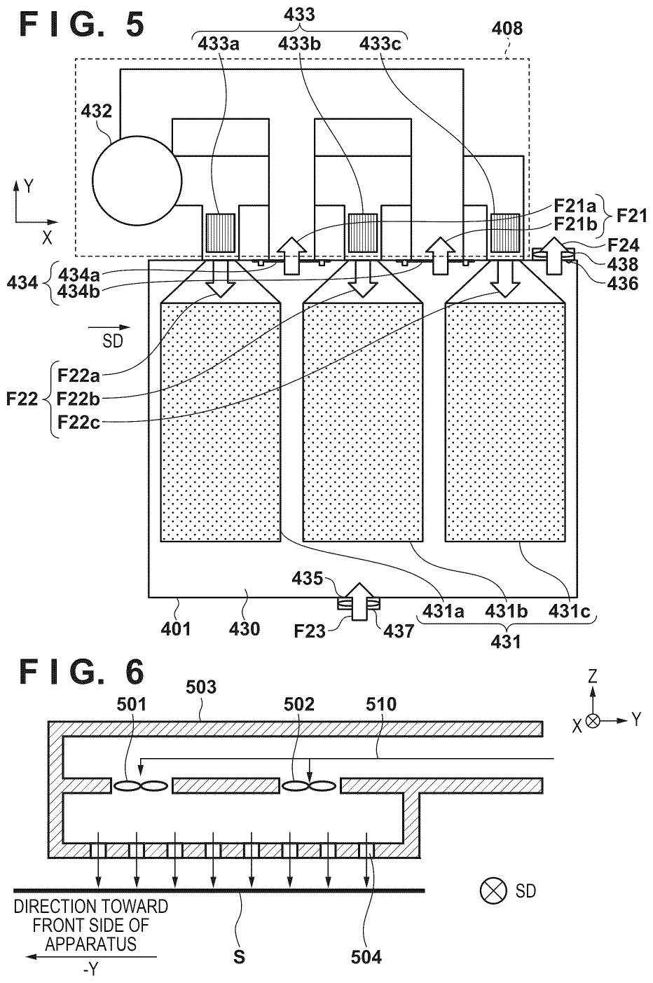

Next, the configuration of the airflow space 430 will be described with reference to FIG. 5. The definitions of directions in FIG. 5 are the same as those in FIG. 4. Specifically, the sheet conveyance direction is defined as an SD direction (X direction), and the sheet width direction is defined as a Y direction. FIG. 5 is a schematic diagram of the airflow space 430 as viewed from the sheet S in the +Z direction. The airflow space 430 is composed of the casing 401 and the plurality of airflow ducts 431 (431a to 431c) accommodated thereinside.

The casing 401 is provided with, in addition to a connection path (not shown) for sending the air to the airflow duct 431, circulation exhaust ports 434 (434a and 434b), a ventilation port 435, and an exhaust port 436.

An air circulation heating unit 408 in which a blower 432 and heaters 433 (433a to 433c) are disposed is provided outside the airflow space 430. The blower 432 sucks the air inside the airflow space 430 in the direction indicated by arrows F21 (F21a and F21b) from the circulation exhaust port 434. The air introduced by suction is blown out from the blower 432 in the directions indicated by arrows F22 (F22a to F22c), and is heated while passing through the heater 433.

The temperature of the heated air is detected by an air temperature detection unit (not shown). Based on the detected temperature, the heating by the heater 433 is controlled according to a predetermined target temperature. In the present embodiment, the temperature of the air that has passed through the heater 433 is controlled within the range from 50 to 100° C. The heated air flows in the directions indicated by the arrows F22, and is blown to the sheet S from the airflow ducts 431. A plurality of circular holes having a small diameter (e.g., a diameter of 1.5 to 5 mm) are formed regularly in each of the airflow ducts 431, and air is uniformly blown out to the sheet S from the circular holes. The holes formed in the airflow duct 431 are not limited to circular holes, and may be composed of linear slit holes, holes having an elliptic shape, or a combination thereof.

When the liquid component of the inks on the sheet S evaporates, the vapor pressure in the airflow space 430 increases. An excessive increase in the vapor pressure inside the airflow space 430 makes it impossible to achieve a desired amount of evaporation, resulting in poor drying. Therefore, outside air is taken in from an intake fan 437 provided in the casing 401, and the air containing vapor is discharged by an exhaust fan 438, thus ventilating the casing 401.

The intake fan 437 takes in outside air in the direction indicated by arrow F23 via the ventilation port 435, and supplies the air into the airflow space 430.

The exhaust fan 438 discharges the air from the airflow space 430 in the direction indicated by arrow F24 via the exhaust port 436. The discharged air is discharged to the outside of the drying unit 40.

Although the ventilation is performed by the intake fan 437 and the exhaust fan 438 in the present embodiment, the ventilation method is not limited thereto. For example, the ventilation may be performed by only one of the fans. The ventilation port 435 and the exhaust port 436 may be provided on the air circulation heating unit 408 side.

Any configuration in which an airflow is blown to the sheet S can be applied to the airflow space 430. For example, the airflow ducts 431 and the air circulation heating unit 408 are not limited to the above-described configurations, and any number of these components may be installed, and these components may be realized by any blowing units, heating units, and the like. In addition, a drying method using a radiant heater may be used, or a radiant heater may be combined with the above-described units.

Although hot air is circulated by the heaters 433 in the present embodiment, air at ordinary temperatures may be circulated without providing the heaters 433.

### Control of Drying Unit 40

Next, a control procedure of the drying unit 40 implemented by the control unit 31 will be described. When print data is transmitted from the host apparatus 33 to the control unit 31, a preparation operation for printing is started in the apparatus.

The control unit 31 determines drive table values of the drying unit 40, based on printing conditions. The conditions for the drive table are determined based on the type and the printing density of the print medium (sheet S) and user-specified values. According to the conditions, the airflow temperature of each airflow duct and the drive DUTY of an air blowing source are specified. The term DUTY means a drive pulse duty cycle of an air blowing source, and a drive signal is output between a DUTY of 0% corresponding to stop and a DUTY of 100% corresponding to full speed. Although the air amount of each airflow duct is adjusted by the drive DUTY of the air blowing source in the present embodiment, the air amount adjustment is not limited to this method. For example, it is possible to adopt a configuration in which a unit (not shown) for detecting the pressure inside the nozzles is provided inside each of the cooling airflow ducts, and the air blowing source is feedback controlled such that the value of the detected pressure is a target pressure value inside the nozzles.

### Configuration of Cooling Unit 50

Next, the above-described configuration of the cooling unit 50 will be described in detail. As in the case of the drying unit 40, the cooling unit 50 of the present embodiment is provided with a plurality of airflow ducts, and constitutes an air-cooling unit. As an example, FIG. 6 is a cross-sectional view of a cooling airflow duct 503 as viewed from the sheet conveyance direction, with the left-right direction assumed as the width direction of the sheet S.

The definitions of directions in FIG. 6 are the same as those in FIG. 4. A fan 501 and a fan 502 are provided in an air passage formed in the cooling airflow duct 503. The air is taken in from the outside of the apparatus, and, as indicated by arrow 510, is blown to the sheet S on the conveyance path via a nozzle unit 504.

### Control of Cooling Unit 50

Next, a control procedure of the cooling unit 50 implemented by the control unit 31 will be described. When print data is transmitted to the control unit 31 from the host apparatus 33, a preparation operation for printing is started in the apparatus.

The control unit 31 determines drive table values of the cooling unit 50, based on printing conditions. The conditions for the drive table are determined based on the type and the printing density of the print medium (sheet S) and user-specified values. According to the conditions, the drive DUTY of each of the fan 501 and the fan 502 of each cooling airflow duct 503 is specified. The term DUTY means a drive pulse duty cycle of a fan, and a drive signal is output between a DUTY of 0% corresponding to stop and a DUTY of 100% corresponding to full speed. Although the air amount of each cooling airflow duct 503 is adjusted by the drive DUTY of the fan in the present embodiment, the air amount adjustment is not limited to this method. For example, it is possible to adopt a configuration in which a unit (not shown) for detecting the pressure inside the nozzles is provided inside each of the airflow ducts, and the air blowing source is feedback controlled such that the value of the detected pressure is a target pressure value inside the nozzles.

### Configuration of First Printing Step

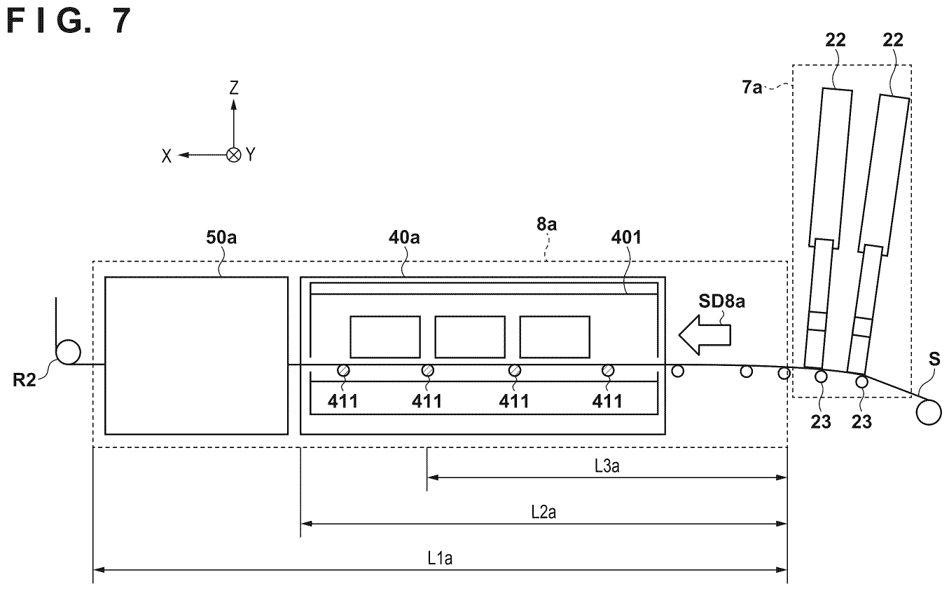

Next, the configuration of the above-described first printing step will be described in detail with reference to FIG. 7. The first printing step is performed by the first printing unit 7a, and a first conveyance path 8a provided side by side with the first printing unit 7a and downstream of the first printing unit 7a in the conveyance direction. The first conveyance path 8a is a conveyance path of the sheet S for a section from the completion of application of inks onto the sheet S by the first printing unit 7a to the arrival of the sheet S at the contact roller R2. The first drying unit 40a and the first cooling unit 50a are disposed in the first conveyance path 8a. In FIG. 7, the sheet conveyance direction in the first conveyance path 8a is defined as SD8a. The other definitions of directions are the same as those in FIG. 4.

In the first printing step, the reaction liquid and the W ink are sequentially applied onto the sheet S by the first printing unit 7a. The sheet S onto which the ink has been applied is subjected to fixing of the ink by the first drying unit 40a in the first conveyance path 8a. Here, to form the sheet conveyance path, a contact roller R2 is provided downstream of the first conveyance path 8a in the SD8a direction. On the contact roller R2, the ink-applied surface on the sheet S and the surface of the contact roller R2 come into contact with each other. In order to keep the ink surface layer applied on the sheet S in a good condition, it is desirable to solidify the ink before the sheet S arrives at the contact roller R2. Therefore, in the present embodiment, the first cooling unit 50a is provided downstream of the first drying unit 40a in the first conveyance path 8a, and solidifies the ink before the sheet S arrives at the contact roller R2.

### Configuration of Second Printing Step

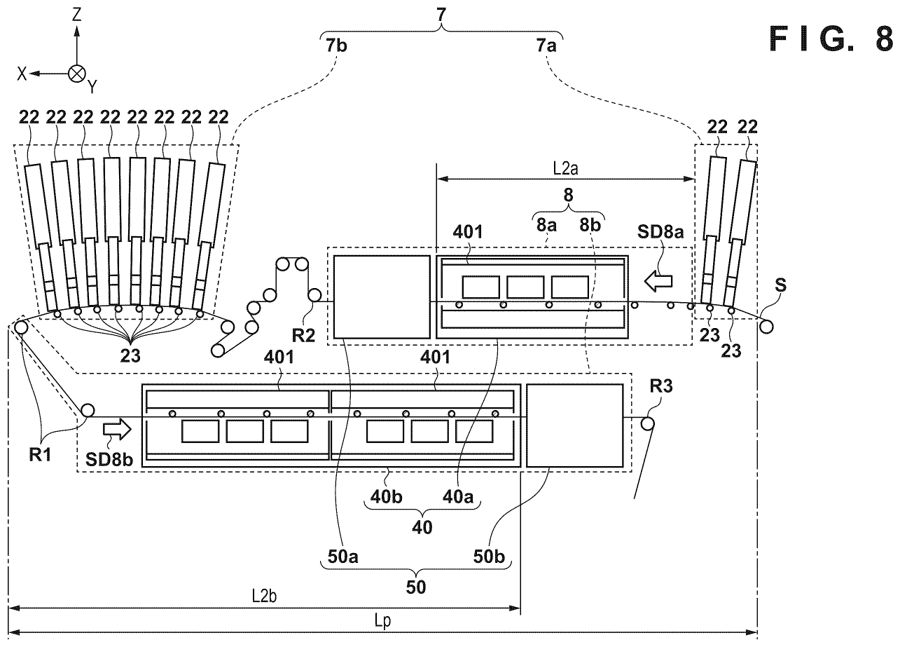

Next, the configuration of the above-described second printing step will be described in detail with reference to FIG. 8. FIG. 8 is a schematic diagram showing a relative positional relationship between the first printing step and the second printing step. The second printing step is performed by the second printing unit 7b, and by a second conveyance path 8b provided downstream of the second printing unit 7b in the conveyance direction.

The second conveyance path 8b is a conveyance path of the sheet S for a section from the completion of application of inks onto the sheet S by the second printing unit 7b to the arrival of the sheet S at the contact roller R3. The winding guide roller R1, the second drying unit 40b, and the second cooling unit 50b are disposed in the second conveyance path 8b. In FIG. 8, the sheet conveyance direction in the second drying unit 40b is defined as SD8b. The other definitions of directions are the same as those in FIG. 4.

In the second printing step, the reaction liquid and a color ink based on a printed image are sequentially applied onto the sheet S by the second printing unit 7b. The sheet S onto which the ink has been applied is folded back toward the lower side of the apparatus by the winding guide roller R1, and thereafter subjected to fixing of the ink by the second drying unit 40b in the second conveyance path 8b. Here, to form the sheet conveyance path, a contact roller R3 is provided downstream of the second conveyance path 8b in the SD8b direction. On the contact roller R3, the ink-applied surface on the sheet S and the surface of the contact roller R3 come into contact with each other. In the second printing step as well, in order to keep the ink surface layer applied on the sheet S in a good condition, it is desirable to solidify the ink before the sheet S arrives at the contact roller R3. Therefore, in the present embodiment, the second cooling unit 50b is provided downstream of the second drying unit 40b in the second conveyance path 8b, and solidifies the ink before the sheet S arrives at the contact roller R3.

### Control of Printing Apparatus

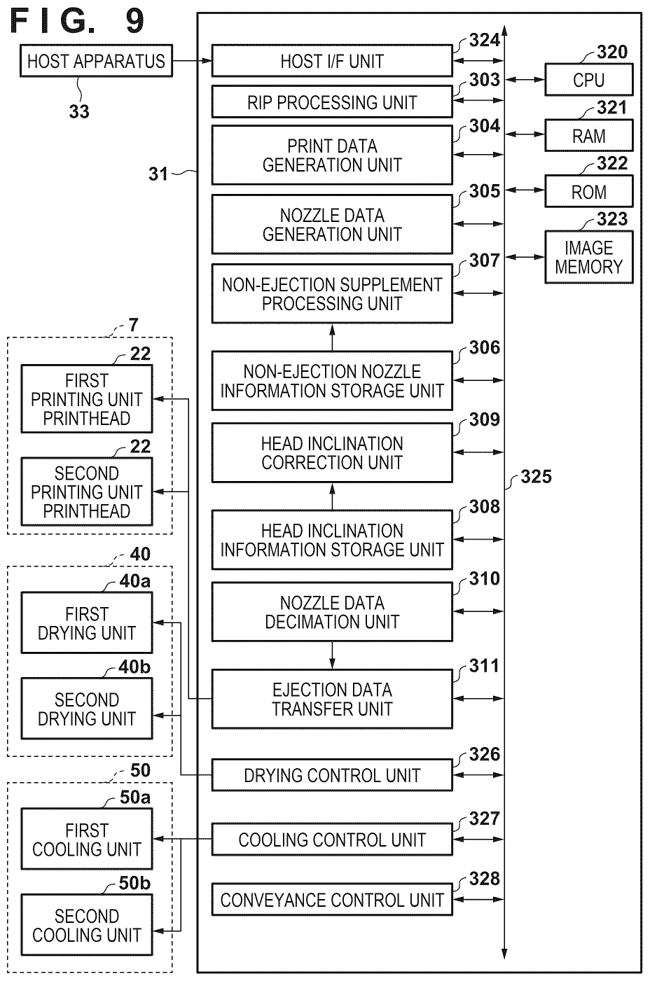

Next, the control unit that performs printing processing in the printing apparatus 1 according to the present embodiment will be described with reference to FIG. 9.

The control unit 31 includes a host I/F unit 324. Print data that has been input from the host apparatus 33 via the host I/F unit 324 is rendered by a RIP processing unit 303, and converted into multi-valued bitmap data. The print data input here is constituted by, for example, a page description language (PDL).

The multi-valued bitmap data is subjected to ink color conversion and quantization processing in the print data generation unit 304, and converted into halftone data of the ink color. The halftone data is assigned to each nozzle by the nozzle data generation unit 305 for each color, and converted into nozzle data (binary data) for each line. The nozzle data is subjected to non-ejection supplement processing (processing of reassigning ejection data assigned to a non-ejection nozzle to a nozzle other than the non-ejection nozzle) by a non-ejection supplement processing unit 307 according to non-ejection nozzle information stored in a non-ejection nozzle information storage unit 306.

The nozzle data that has been subjected to the non-ejection supplement processing is subjected to head inclination correction (correction of moving data in the conveyance direction in accordance with the inclination amount) performed by a head inclination correction unit 309 according to head inclination information stored in a head inclination information storage unit 308. The nozzle data that has been subjected to the head inclination correction in this manner is stored in an image memory 323.

A CPU 320 transfers the nozzle data stored in the image memory 323 to a nozzle data decimation unit 310. The transferred nozzle data that has been subjected to inclination correction is subjected to decimation processing by the nozzle data decimation unit 310, and transferred to the printheads 22 of the first printing unit 7a and the second printing unit 7b by the ejection data transfer unit 311.

In addition, the CPU 320 performs control of the above-described units. The control is performed based on control programs stored in a ROM 322. The control programs stored in the ROM 322 includes an operation system (OS) for performing time-division control in units of load modules by a system clock. A RAM 321 is used as a work area of the CPU 320. The units including the CPU 320 are connected to a system bus 325.

The control unit 31 includes a drying control unit 326, a cooling control unit 327, and a conveyance control unit 328. The drying control unit 326 controls the temperatures of the first drying unit 40a and the second drying unit 40b, and the driving of the blowers thereof. The cooling control unit 327 controls the cooling operation of the first cooling unit 50a and the second cooling unit 50b. The conveyance control unit 328 controls the conveyance units (the unwinding roll unit 2, the first dancer unit 3, the first main conveyance unit 4, the meandering correction unit 5, the conveyance detection unit 6, the conveyance tension detection unit 9, the second main conveyance unit 12, the second dancer unit 13, and the winding roll unit 14) from the unwinding roll unit 2 to the winding roll unit 14, and conveys the sheet S at a predetermined conveyance speed.

When print data is input from the host apparatus 33, the drive table is applied to each of the drying control unit 326, the cooling control unit 327, and the conveyance control unit 328, based on the print data. In the drive table, predetermined values based on the printing conditions such as image data and types of the print medium (sheet S), or values input by a user through the operation unit 32 and the like are registered. By performing control based on the printing conditions, appropriate printing processing according to the image data, the print medium, the desired productivity and the like can be realized.

Here, although the internal configuration of the printing apparatus 1 is shown in FIG. 1, if the components inside the printing apparatus are configured within one casing frame, the transport of the casing frame may become difficult. For this reason, the casing frame of the printing apparatus may be divided into multiple casing frames, and the functional units may be separately configured in the respective casing frames.

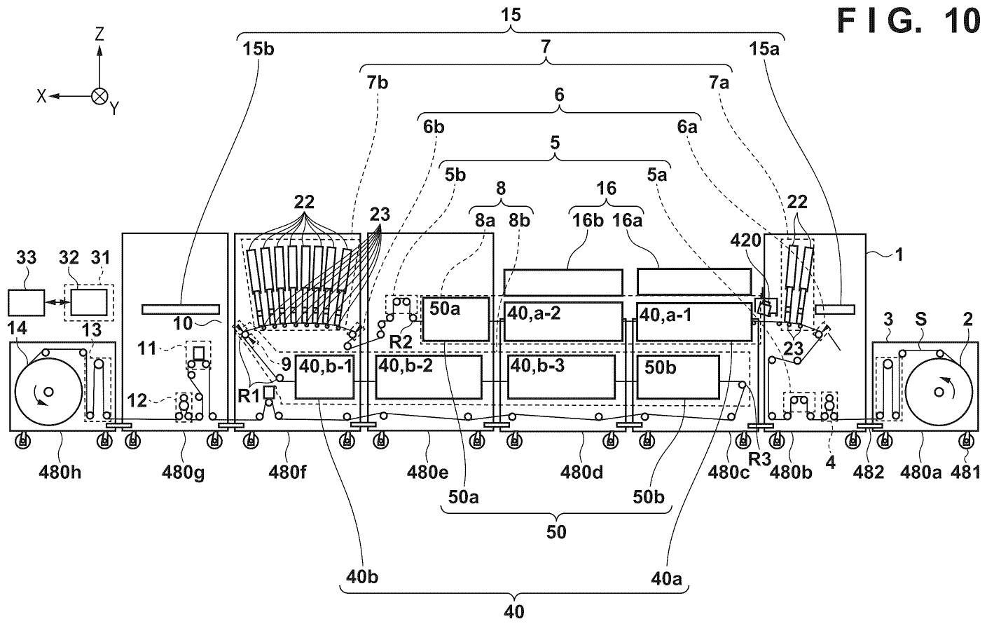

FIG. 10 shows an example in which the printing apparatus 1 shown in FIG. 1 as an example is divided into eight casing frames 480 (480a to 480h).

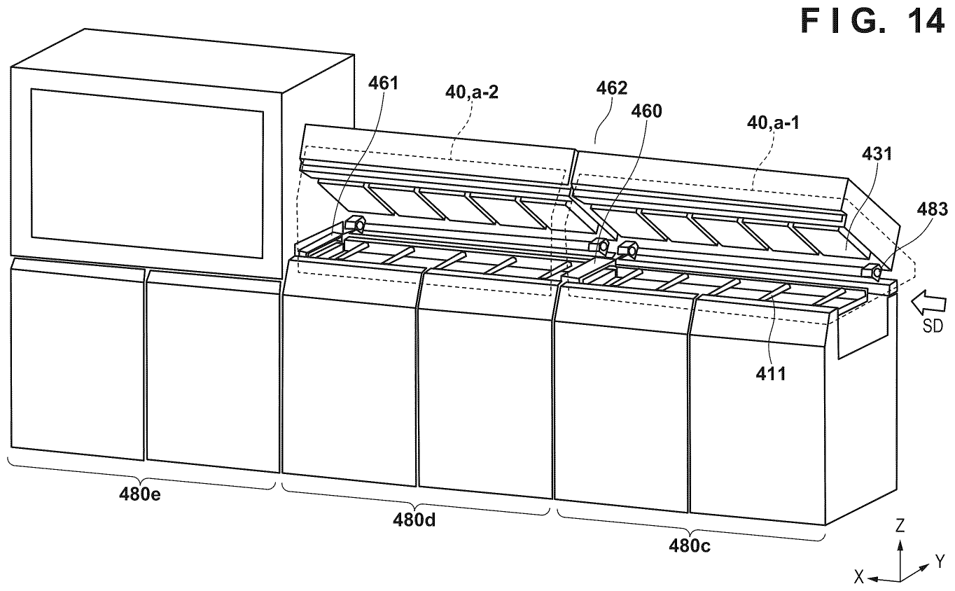

The printing apparatus 1 is divided into, in the following order from the right side of the apparatus, a casing frame 480a in which the unwinding roll unit 2 and the like are disposed, a casing frame 480b in which the first printing unit 7a, the first main conveyance unit 4, and the like are disposed, a casing frame 480c in which a first ink feed device 16a, a first drying unit 40_a1, a second cooling unit 50b, and the like are disposed, a casing frame 480d in which a second ink feed device 16b, a first drying unit 40_a2, and a second drying unit 40_b3 are disposed, a casing frame 480e in which the first cooling unit 50a, a second drying unit 40_b2, and the like are disposed, a casing frame 480f in which the second printing unit 7b, a second drying unit 40_b1, and the like are disposed, a casing frame 480g in which the second main conveyance unit 12 and the like are disposed, and a casing frame 480h in which the winding roll unit 14 and the like are disposed. In such a divided casing frame configuration, the casing frames 480a to 480h are transported separately from each other. At the transport destination, using casters 481 provided on a lower surface of each of the casing frames 480, the casing frames 480 are arranged side by side as shown in FIG. 14. Furthermore, the casing frames 480 are coupled and fixed to each other using coupling members 482. Thus, the printing apparatus 1 becomes usable.

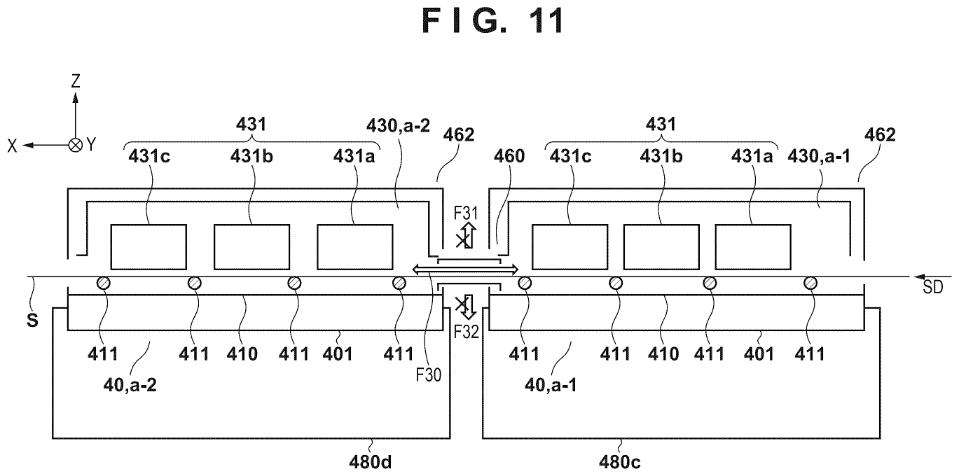

Here, in the present embodiment, the airflow space 430 described with reference to FIG. 4 extends over two casing frames as shown in FIG. 11, and is divided into an airflow space (a blowing space and a conveyance space of the sheet S) 430_a1 in the casing frame 480c, and an airflow space (a blowing space and a conveyance space of the sheet S) 430_a2 in the casing frame 480d. In this case, a first airflow sealing member (connection member) 460 is disposed between the casing frames, and a closed space that prevents leakage of airflow is formed.

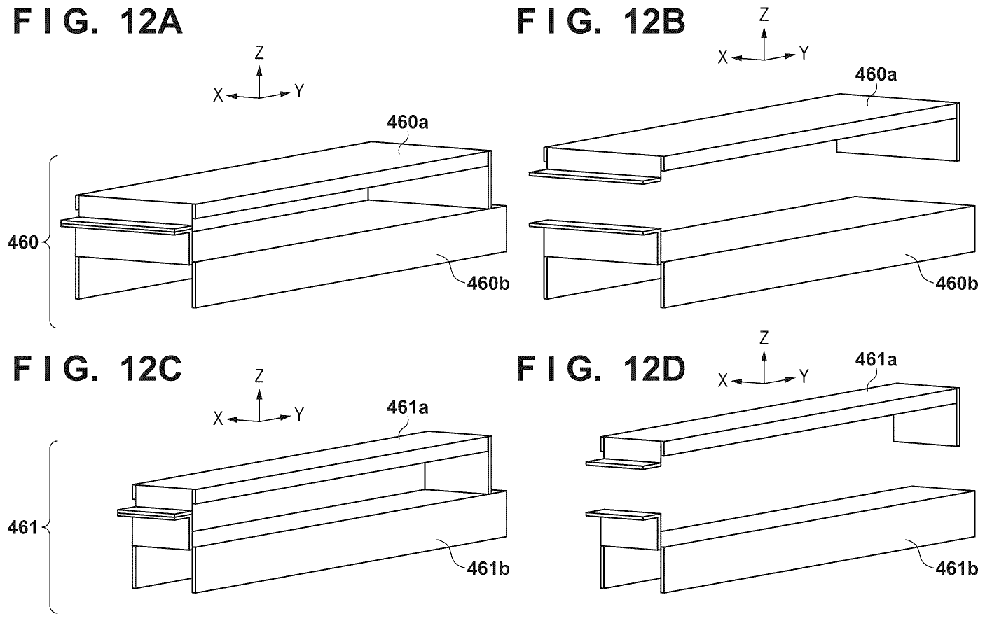

FIGS. 12A and 12B are detailed views of the first airflow sealing member 460. The first airflow sealing member 460 is composed of an upper first airflow sealing member (upper member) 460a, and a lower first airflow sealing member (lower member) 460b, and the sheet S passes through the space between the two members. If the first airflow sealing member 460 is not provided, the flows of air indicated by arrows F31 and F32 shown in FIG. 11 are generated to cause leakage of warm air, which may result in a reduction in the efficiency of drying the sheet S. However, in the present embodiment, the airflow space 430_a1 and the airflow space 430_a2 are connected by the first airflow sealing member 460 as shown in FIG. 11. Thus, the flows of air generated in the first drying unit 40_a1 and the first drying unit 40_a2 flow in the direction indicated by arrow F30, and the flows of air in the directions indicated by arrows F31 and F32 are suppressed. Accordingly, the efficiency of drying the sheet S is maintained.

Additionally, let us consider a case where a foreign object such as a clip falls off from a gap between the casing frame 480c and an exterior surface 462 of the casing frame 480d. In this case, if the first airflow sealing member 460 is not provided, the foreign object may enter the drying unit 40, and cause a problem in the apparatus. In addition, the foreign object may get into a lower portion of the casing frame that is unreachable. In this respect, in the present embodiment, the provision of the first airflow sealing member 460 allows the fallen foreign object to be held on an upper surface of the first airflow sealing member 460, and therefore the foreign object can be easily collected.

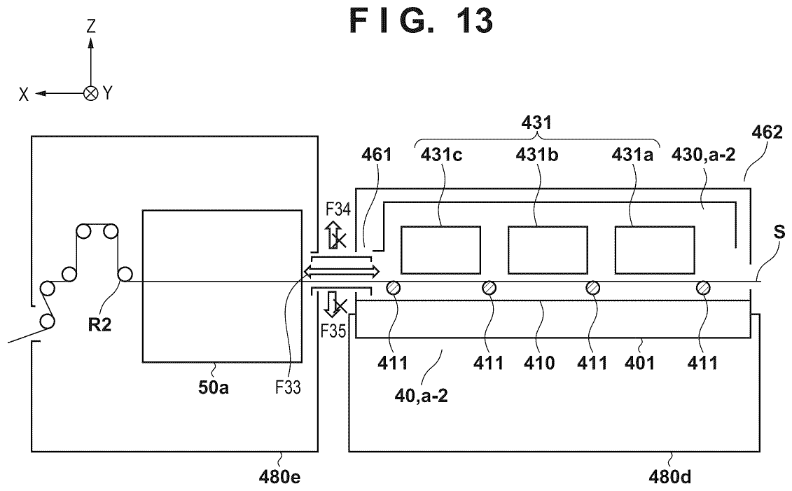

The airflow sealing member is not limited to be disposed between the casing frames including the first drying units 40 adjacent to each other as shown in FIG. 11. FIG. 13 shows an example in which a second airflow sealing member 461 is disposed between the casing frame 480d and the casing frame 480e.

FIGS. 12C and 12D are detailed views of the second airflow sealing member 461. As in the case of the first airflow sealing member 460, the second airflow sealing member 461 is composed of an upper second airflow sealing member 461a and a lower second airflow sealing member 461b, and the sheet S passes through the space between the two members. If the second airflow sealing member 461 is not provided, as in the above described case, flows of air in the directions indicated by arrows F34 and F35 may be generated, which may cause a reduction in the efficiency of drying the sheet S. However, in the present embodiment, the airflow space 430_a2 and the first cooling unit 50a are connected by the second airflow sealing member 461 as shown in FIG. 13. Thus, the flows of air generated in the first drying unit 40_a2 and the first cooling unit 50a flow in the direction indicated by arrow F33, and the flows of air in the directions indicated by arrows F34 and F35 are suppressed. Accordingly, the efficiency of drying the sheet S is maintained. As in the case of the first airflow sealing member 460 described above, the fall of the foreign object can also be suppressed.

Considering the separation of the casing frames during transport, when, as in the case of FIG. 11, the first airflow sealing member 460 overlaps the first drying unit 40_a1 and the first drying unit 40_a2 in the X direction of the drawing, it is difficult to separate the casing frames due to the interference between the first airflow sealing member 460 and the casing frames. Even if the casing frames can be separated, the first airflow sealing member 460 projects from the silhouettes of the casing frames. Therefore, when the first airflow sealing member 460 is kept attached to the casing frames, the packing space during transport is wasted, which is not preferable. Therefore, it is desirable that the first airflow sealing member 460 can be freely attached to and detached from (attachable to and detachable from) the printing apparatus 1. For the same reason, it is also desirable that the second airflow sealing member 461 can be freely attached to and detached from the printing apparatus 1. The first airflow sealing member 460 and the second airflow sealing member 461 may be configured to be accommodated in the casing frames. In this case, it is possible to reduce a waste of packing space by accommodating these members inside the casing frames during transport.

FIG. 14 is a perspective view illustrating how the sheet S is passed through the first drying unit 40_a1 and the first drying unit 40_a2. The periphery of the airflow duct 431 is retractable so as to be opened upward in the Z axis (openable and closable) using a hinge portion (rotational shaft) 483 disposed on the back side as a support point, and the sheet support rollers 411 are fixed to the casing frames. In the case of passing the sheet S through this opening region in the SD direction, the sheet S may be passed through the first airflow sealing member 460 by letting the sheet S pass between the upper first airflow sealing member 460a and the lower first airflow sealing member 460b, resulting in poor workability.

For this reason, it is desirable that the upper first airflow sealing member 460a is configured to be separated from the lower first airflow sealing member 460b as shown in FIG. 12B. The workability can be improved by passing the sheet S through the first airflow sealing member 460 while the upper first airflow sealing member 460a is separated. The same applies to the case where the sheet S is passed through the second airflow sealing member 461, and it is desirable that the upper second airflow sealing member 461a is configured to be separated from the lower second airflow sealing member 461b as shown in FIG. 12D.

As described thus far, according to the first embodiment, even when the casing frame of the printing apparatus is divided into multiple casing frames, and the drying units are separately disposed in the respective casing frames, it is possible to prevent leakage of warm air by placing the sealing member between the casing frames.

### Second Embodiment

Next, a second embodiment will be described. In the following description, the overall configuration of the printing apparatus, the configuration of the drying unit 40, and the like are the same as those of the first embodiment. Therefore, constituent elements that are the same as those of the first embodiment are denoted by the same reference numerals, and descriptions thereof have been omitted where appropriate.

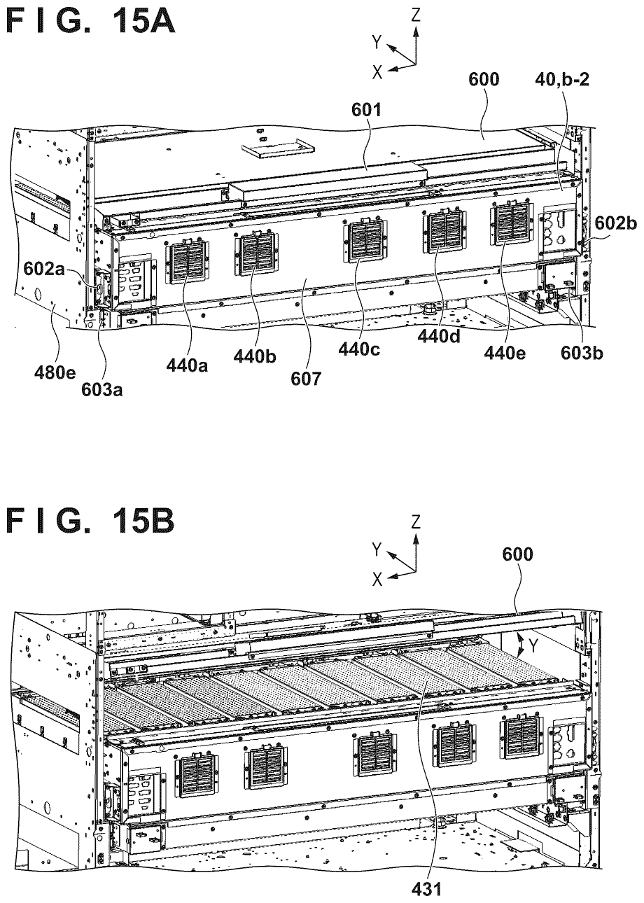

FIG. 15 shows perspective views showing an outward appearance of the second drying unit 40_b2 from among the second drying unit 40_b1 to 40_b3. As shown in FIG. 10, the second drying unit 40_b1 is a unit smaller than the second drying unit 40_b2 in the conveyance direction, and the second drying unit 40_b3 is a unit having the same size as the second drying unit 40_b2. FIG. 15A is a perspective view of the second drying unit 40_b2 when a cover 600 for closing the upper portion of the second drying unit 40_b2 is closed. FIG. 15B is a perspective view of the second drying unit 40_b2 when the cover 600 is open.

With reference to FIG. 15A, the configuration of the drying unit will be described. To facilitate understanding of the description, electric cables 608, connection portion covers 610, and the like, which will be described later, are omitted in FIG. 15A.

In FIG. 15A, a substantially box-shaped accommodation unit 607 (blowing unit) accommodating the second drying unit 40_b2 is configured to be drawable from the casing frame 480e in the −Y direction. Slide rails 603a and 603b are provided between the casing frame 480e and the accommodation unit 607 on the downstream side and the upstream side, respectively, in the conveyance direction of the sheet S, whereby the accommodation unit 607 can be drawn toward the front side (−Y direction) of the apparatus in FIG. 15A.

As a result of pins (not shown) provided on the casing frame 480e being fitted with holes in positioning portions 602a and 602b provided on the accommodation unit 607 side, the accommodation unit 607 is positioned while being accommodated in the casing frame 480e. Filters 440a to 440e are provided on the front side (−Y direction) of the apparatus, and constitute inlets for taking outside air into the second drying unit 40_b2. The filters 440 prevent dust contained in outside air from flowing into the apparatus. A cover 600 and a handle 601 thereof are provided above the accommodation unit 607.

FIG. 15B shows a state in which the cover 600 is opened by an angle γ in contrast to FIG. 15A. When the cover 600 is opened, the airflow ducts 431 are exposed. In a case where paper powder has attached to the conveyance units due to the use of the apparatus body, a user can clean out the paper powder with a cloth or the like. For this purpose, in order to secure a space into which a user can put his or her hands on the rear side (+Y direction) of the apparatus in the paper width direction (the width direction of the sheet S), γ is set to 15°. As shown in FIG. 10, since the first cooling unit 50a is disposed above the second drying unit 40_b2, the opening angle γ of the cover 600 is set to an angle at which the cover 600 does not interfere with the first cooling unit 50a when opened.

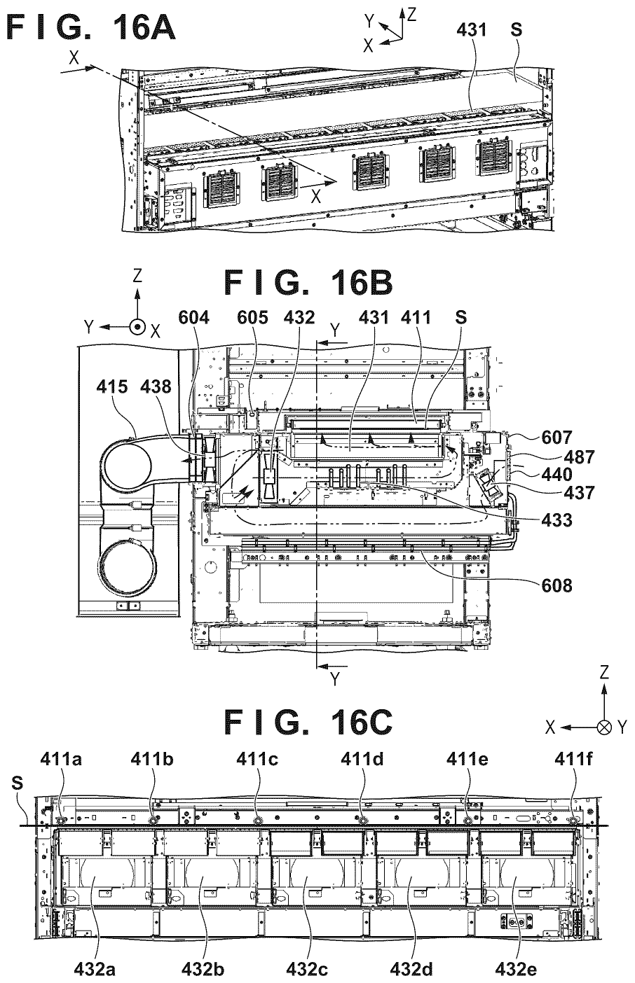

FIG. 16 shows a perspective view and cross-sectional views of the second drying unit 40_b2 in a case where the sheet S is present, in contrast to FIG. 15. FIG. 16A is a perspective view showing a state in which an elongated continuous sheet S is present within the apparatus, corresponding to the state in which the cover 600 is opened, shown in FIG. 15B. FIG. 16B is a cross-sectional view taken along the line X-X in FIG. 16A.

With reference to FIG. 16B, the structure of the second drying unit 40_b2 will be described. The second drying unit 40_b2 has a configuration in which the first drying units 40_a1 and 40_a2 described above are disposed upside down, and is disposed such that warm air acts on the print surface side of the sheet S.

Outside air that has been taken in from the filters 440 on the front side of the apparatus is blown by the intake fan 437 and sent below the accommodation unit 607 to the rear of the apparatus along a path indicated by the dashed double-dotted line in the drawing. Then, the outside air is blown in the reverse direction by the blower 432 at the rear of the apparatus in a direction toward the front side of the apparatus, and heated by the heaters 433. Thereafter, the heated warm air is further blown to the rear of the apparatus so as to turn around, and jetted from a large number of holes of the airflow ducts 431 toward the sheet S.

The sheet support rollers 411 are disposed on the upper side, that is, the side opposite to the side of the sheet S against which warm air is blown, and restricts the position of the sheet S such that the distance between the sheet S and the airflow ducts 431 is a desired appropriate distance. Both ends of each of the sheet support rollers 411 are supported so as to be rotatable in the sheet conveyance direction relative to the cover 600.

After blown to the sheet S, the warm air is sent in a direction toward the rear side of the apparatus (the direction indicated by the dashed double-dotted line in the drawing), and part of the warm air is circulated by the blower 432 toward the front of the apparatus. In addition, highly humid air generated as a result of evaporation of the inks is sent by the exhaust fan 438 to an exhaust duct 415 via an interface unit 604, and discharged to the outside of the apparatus. In this manner, the interior of the accommodation unit 607 is maintained at a desired humidity.

Electric cables 608 for feeding power and sending control signals to the above-described fans and heaters are disposed below the accommodation unit 607.

FIG. 16C is a cross-sectional view taken along the line Y-Y in FIG. 16B. FIG. 16C shows a state in which the sheet S is supported by the sheet support rollers 411a to 411f. In the present embodiment, a roller is used as a sheet support unit (backup member). However, the present disclosure is not limited thereto, and the same effect can also be achieved by a structure in which the non-print surface side of the sheet S is supported by a plate-shaped platen.

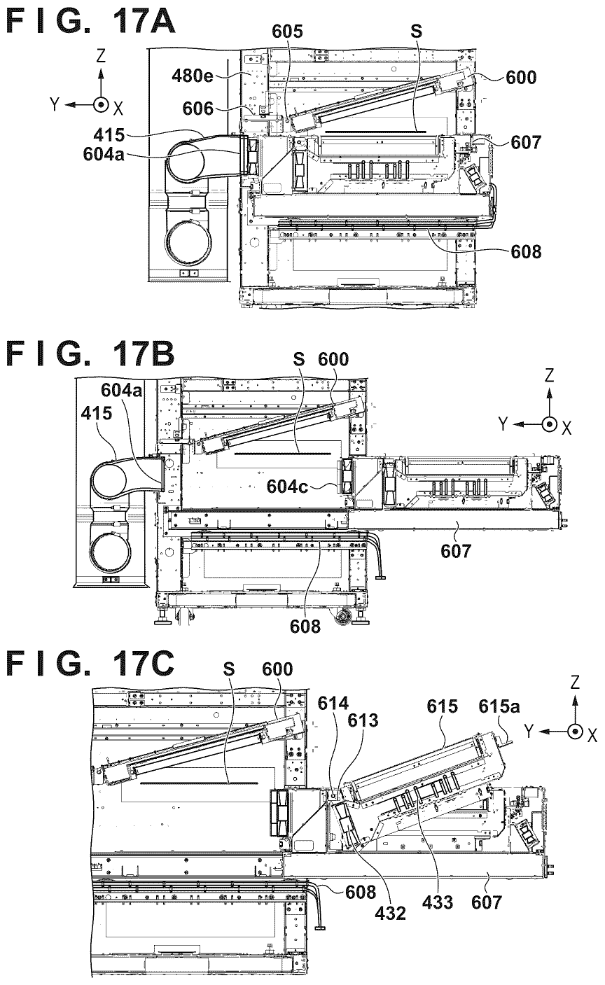

FIG. 17 shows diagrams illustrating a process of opening the cover 600 upward, and drawing the accommodation unit 607 in a direction toward the front side of the apparatus, in contrast to FIG. 16.

FIG. 17A is a diagram showing a state in which the cover 600 is open, in contrast to FIG. 16B. This state is the same as the above-described state shown in FIG. 16A.

The cover 600 is configured to be openable and closable using, as a rotation support point, a hinge portion 605 provided on a bracket 606 provided at the rear of the casing frame 480e. The cover 600 is configured to be maintained in a state in which the cover 600 is opened by an elastic unit (gas spring) (not shown) to the angle γ shown in FIG. 15B relative to the casing frame 480e after being opened.

FIG. 17B is a diagram showing a state in which the accommodation unit 607 is drawn forward of the apparatus. Here, the interface unit 604 is a sealing member made of an elastic material. When an interface unit 604a on the exhaust duct (exhaust path) 415 side and an interface unit 604c on the accommodation unit 607 side are spaced apart from each other when the accommodation unit 607 is drawn as shown in the drawing. As described above, the cover 600 is supported by the hinge portion 605 relative to the casing frame 480e, thus preventing the cover 600 from being caught on the sheet S to prevent the accommodation unit 607 from being drawn. By adopting such a configuration, there is no need to cut the sheet S to draw the accommodation unit 607, and it is therefore possible to save the user's time and effort to reconnect the cut portions of the sheet S.

Furthermore, FIG. 17C shows a process of removing a drying module 615 from the accommodation unit 607 when, for example, the blowers 432 or the heaters 433 are replaced, in contrast to FIG. 17B.

An L-shaped portion 615a of the drying module 615 is fastened to the accommodation unit 607 with screws (not shown). When the drying module 615 is rotated relative to a U-groove portion 613 of the accommodation unit 607 about a shaft portion 614 at the rear as in FIG. 17C, the drying module 615 can be removed forward and upward of the apparatus as shown in the drawing. If the accommodation unit 607 is not drawn from the casing frame 480e, the opening angle of the cover 600 may be nearly doubled in order to remove the drying module 615 from the apparatus body. For this reason, a space corresponding to the rotation locus of the cover 600 may be used, and it may therefore be useful to increase the height of the apparatus body. Accordingly, by adopting the configuration of the present embodiment that allows the accommodation unit 607 to be drawn, it is possible to reduce the size of the apparatus while maintaining good service performance and maintenance performance of the apparatus.

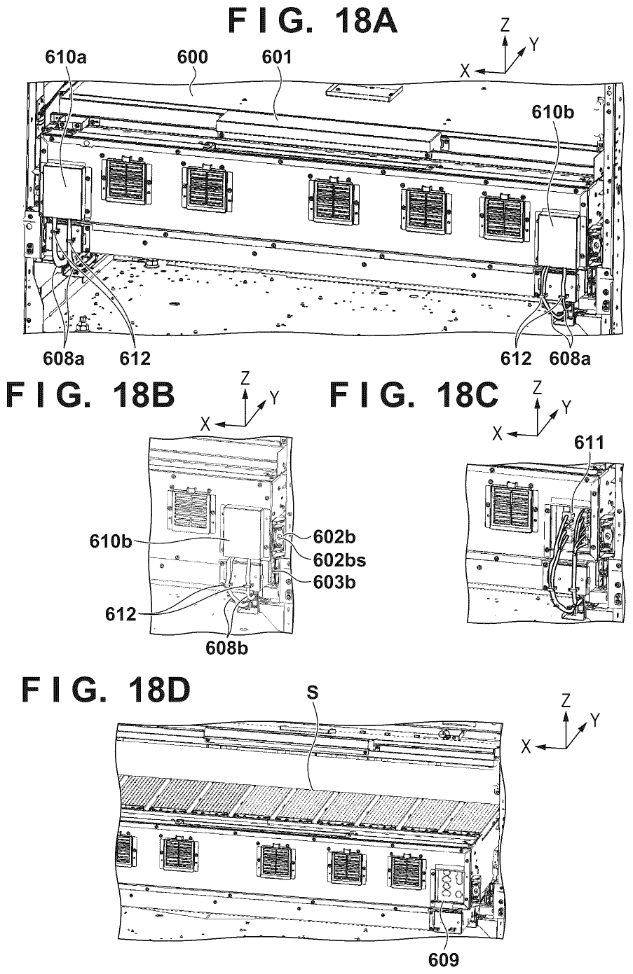

FIG. 18 shows explanatory diagrams relating to the connection of the electric cables on the front side of the apparatus. FIG. 18A is a diagram in which the electric cables (wiring) 608 are added to FIG. 15A. As described above, electric cables 608a and 608b are groups of cables used for power feeding and transmission of control signals to the fans and the heaters in the second drying unit 40_b2.

The electric cables 608a and 608b are fixed by fixing members 612 provided on opposite sides of the accommodation unit 607 in the conveyance direction. A connector 611, which will be described later, is covered by protective connection portion covers 610a and 610b so as to prevent accidental disconnection.

FIG. 18B is an enlarged diagram of the conveyance direction upstream side of FIG. 18A. A positioning portion 602b and a slide rail 603b are disposed directly beside the connection portion cover 610b. The positioning portion 602b is fastened to the accommodation unit 607 with a screw 602bs. When the accommodation unit 607 is drawn from the casing frame 480e, the connection portion cover 610b is removed. Upon removal, a plurality of connectors 611 to which the electric cable 608b is connected are exposed as shown in FIG. 18C. By pulling out the electric cable 608b from the connectors 611 to release the fastening of the screw 602bs, a connection portion 609 is no longer physically restrained as shown in FIG. 18D, and the accommodation unit 607 becomes drawable.

The same applies to a connection portion 609 on the downstream side in the conveyance direction. By adopting the configuration according to the present embodiment, it is possible to reduce the space and the cost used for the apparatus as compared with a configuration in which the length of the electric cables 608 is secured taking the drawing amount of the accommodation unit 607 into consideration.

Although the present embodiment has been described taking the drying module as an example, the same effect can also be achieved by a blowing unit that merely cools the sheet without heating air.

### Maintenance Method of Exhaust Fan 438

Next, a configuration in which an exhaust duct is provided on the back side of the drying unit of the accommodation unit 607, while allowing the accommodation unit 607 to be easily drawn will be described.

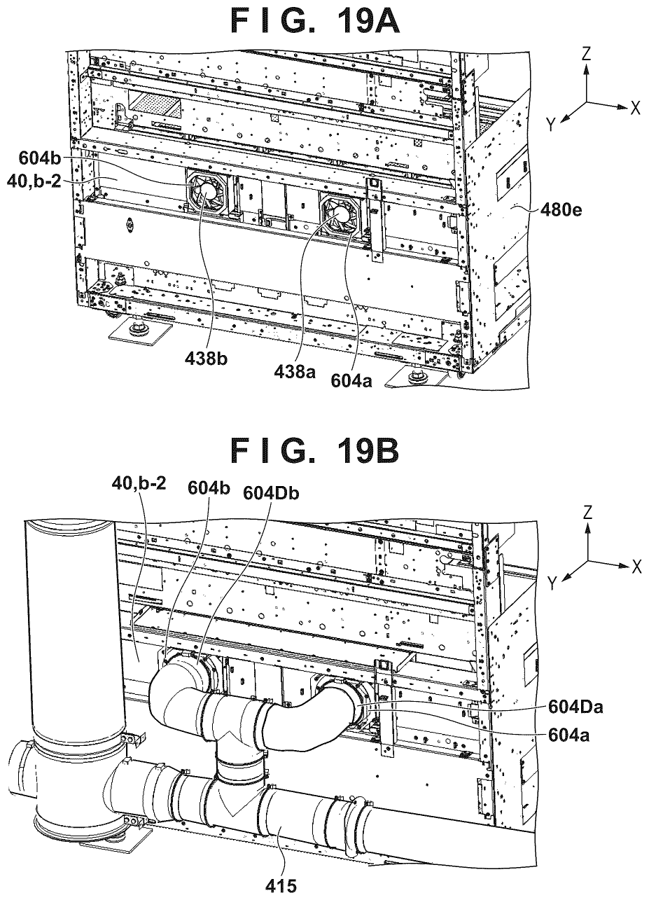

FIG. 19 shows diagrams illustrating an interface unit on the second drying unit 40_b2 side. FIG. 19A is a perspective view on the rear side of the second drying unit 40_b2.

Two exhaust fans 438a and 438b are provided on the rear side of the second drying unit 40_b2 in accordance with the total gas flow rate. The interface units 604 (604a and 604b) are disposed on the profiled portions of the exhaust fans 438a and 438b.

FIG. 19B shows a state in which the exhaust duct 415 is connected, in contrast to FIG. 19A.

Interface units 604D (604Da and 604Db) of the exhaust duct 415 abut against the interface units 604a and 604b. This prevents exhaust air from leaking to the outside. A configuration is possible in which the accommodation unit 607 and the exhaust duct 415 are connected by a flexible hose such as a corrugated hose in accordance with the movement amount by which the accommodation unit 607 is drawn forward of the apparatus. However, it may be helpful to secure the space for accommodating the length of the hose. In addition, the increased length of the flow path also results in an increased pressure loss, for example. In contrast, the provision of the interface units 604 as that of the present embodiment makes it possible to move the accommodation unit 607, and achieve an efficient flow of air. In the present embodiment, the interface units 604 are disposed in the front-rear direction of the apparatus. However, the same effect can also be achieved by providing the interface units 604 in the left-right direction of the apparatus (i.e., the conveyance direction).

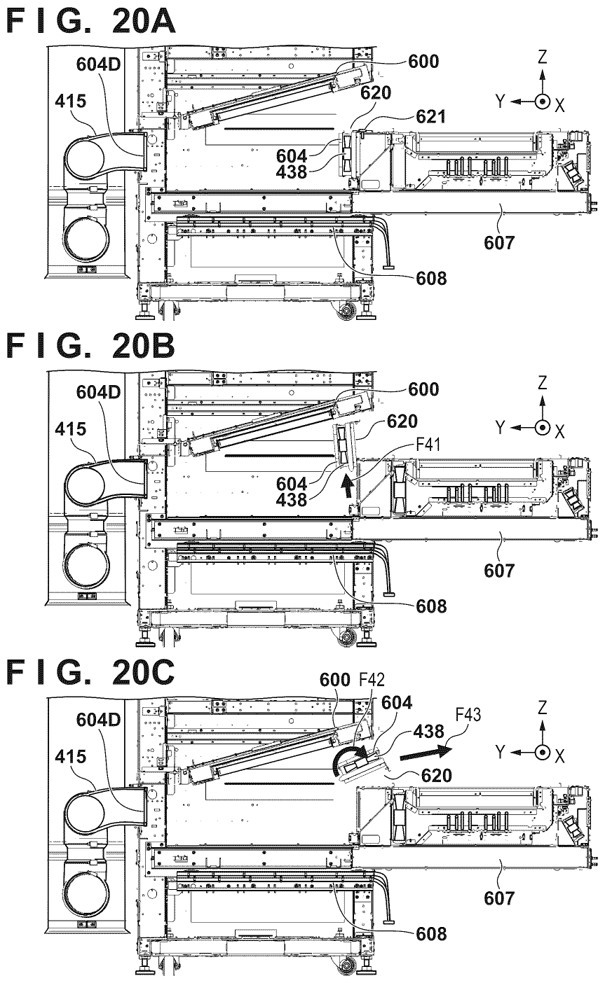

Next, a method for maintenance of the exhaust fans 438a and 438b provided on the back side of the drying units will be described. FIG. 20 shows diagrams illustrating a method for removing the exhaust fans 438a and 438b from the second drying unit 40_b2.

As shown in FIG. 19A, the exhaust fan 438a and the exhaust fan 438b are arranged side by side in the X direction, and the removal method does not vary depending on the arrangement. Therefore, the exhaust fans 438a and 438b hereinafter will be described as the exhaust fan 438 without being differentiated from each other.

FIG. 20A is a diagram showing the drying unit and the exhaust fan 438 in a drawn state. An exhaust fan unit 620 composed of the exhaust fan 438 and the interface unit 604 is fixed to the drying unit with a fixing member 621. Since the cover 600 is open, a relay portion (not shown) between the fixing member 621 and the harness of the exhaust fan can be removed by being accessed from the +Z side (upper side).

FIG. 20B is a diagram showing a process of removing the exhaust fan unit 620 from the drying unit after removing the fixing member 621. Since the cover 600 is open, the exhaust fan unit 620 can also be removed in the direction indicated by arrow F41 by being accessed from the +Z side (upper side).

FIG. 20C is a diagram showing the removal of the drawn exhaust fan unit 620 to the outside of the apparatus. The exhaust fan unit 620 that has been removed to an opening between the cover 600, and the accommodation unit 607 can be completely removed to the outside of the apparatus by being inclined in the direction indicated by arrow F42, and thereafter being removed in the direction indicated by arrow F43. After completion of the maintenance of the exhaust fan 438, the exhaust fan unit 620 can be attached by reversing this procedure.

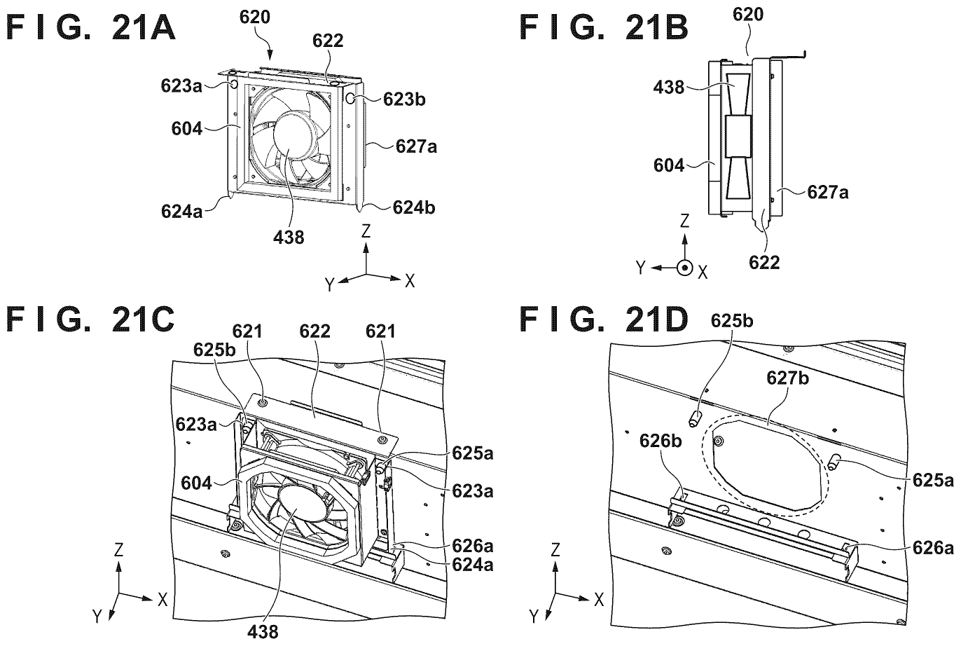

Next, the details of the exhaust fan unit 620 will be described. FIG. 21 shows diagrams showing configurations of the exhaust fan unit 620 and the second drying unit 40_b2. FIG. 21A is a perspective view of the exhaust fan unit 620, and FIG. 21B is a cross-sectional view of the exhaust fan unit 620.

The above-described exhaust fan 438 and interface unit 604 that constitute the exhaust fan unit 620 are fixed to an exhaust fan holding plate 622. The exhaust fan holding plate 622 is provided with a guide pin insertion holes 623a and 623b, and protrusions (restricting members) 624a and 624b. These components have shapes used for defining the position when fixing the exhaust fan unit 620 to the second drying unit 40_b2.

A drying interface unit 627a is attached to the exhaust fan holding plate 622, and abuts against a drying interface unit 627b, which will be described later, when being attached to the drying unit 40_b2. The drying interface unit 627a is made of a sponge material that can be deformed in the compression direction, and prevents exhaust air from leaking from the space between the drying unit 40_b2 and the exhaust fan 438.

FIG. 21C is a diagram showing the detailed configuration of the exhaust fan unit 620 attached to the drying unit 40_b2. The exhaust fan 438 is fixed, together with the exhaust fan holding plate 622, to the drying unit 40_b2 by the fixing member 621. Guide pins 625a and 625b provided on the drying unit 40_b2 side are inserted into the guide pin insertion holes 623a and 623b. The protrusions 624a and 624b are inserted into positioning holes 626a and 626b. FIG. 21D is a diagram showing the details of the drying unit 40_b2. The guide pins 625a and 625b, the positioning holes 626a and 626b into which the protrusions 624a and 624b are inserted, and a drying interface unit 627b are provided on the drying unit 40_b2 side. Thus, the exhaust fan unit 620 can be fixed only by the fixing member 621 that can be accessed in a state in which the accommodation unit 607 is drawn. In the above description, the drying interface unit 627a made of sponge material is attached to the exhaust fan holding plate 622. However, a sponge material may be provided on the drying unit 40_b2 side.

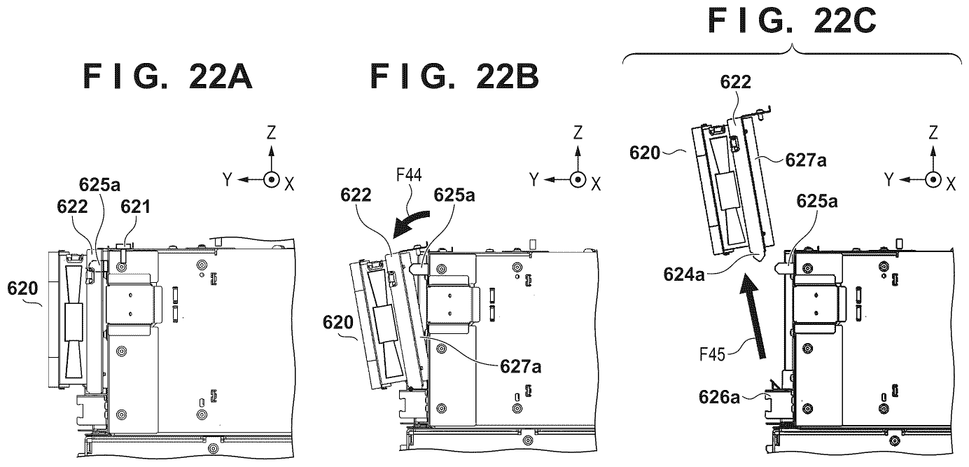

Next, a procedure for removing the exhaust fan unit 620 from the second drying unit 40_b2 will be described. FIG. 22 is a diagram showing a locus of removal of the exhaust fan unit 620.

FIG. 22A is a cross-sectional view showing a state in which the exhaust fan unit 620 is fixed to the second drying unit 40_b2, and the guide pin 625a is inserted into the exhaust fan holding plate 622 as previously described. The inserted portion of the guide pin 625a is indicated by the dotted line.

FIG. 22B is a diagram showing a process of removing the fixing member 621 to release the fixing of the exhaust fan unit 620. The inserted state of the guide pin 625a is released by inclining the exhaust fan unit 620 in the direction indicated by the arrow F44. Accordingly, the exhaust fan unit 620 can be moved to the +Z direction side. At the same time, the compressed state of the drying interface unit 627a that has been compressed and attached in the Y direction in order to fill the gap between the exhaust fan unit 620 and the second drying unit 40_b2 can also be released, thus making it possible to smoothly perform the subsequent removal.

FIG. 22C is a diagram showing a method for removing the exhaust fan unit 620 from the second drying unit 40_b2. As previously described, the protrusion 624a is pulled out from the positioning hole 626a by moving the exhaust fan unit 620 in the direction indicated by arrow F45 in a state in which the insertion of the guide pin 625a is released. The same applies to the guide pin 625b, the protrusion 624b, and the positioning hole 626b. The direction indicated by the arrow F45 is a direction of a vector component of the exhaust fan unit 620 moving away from the drying unit 40_b2 in the Y direction. Therefore, a state in which the drying interface unit 627a interferes with the second drying unit 40_b2, making the removal thereof difficult, is prevented. The exhaust fan unit 620 can be attached by reversing the above-described procedure.

By utilizing the above-described configuration, various devices disposed on the back side in the drawing direction of the second drying unit 40_b2 can also be replaced. For example, when a temperature sensor (not shown) for measuring the temperature of an airflow immediately before being taken in by the blower 432 shown in FIG. 16B, or an airflow immediately before being discharged by the exhaust fan 438 is disposed, the same configuration can also be applied to a temperature sensor unit. This makes it possible to remove, with good workability, various devices, including the exhaust fan unit 620, from the second drying unit 40_b2, while avoiding the adverse effect on the removal by the drying interface unit 627a that can be compressed, thus improving the maintainability.

As described thus far, according to the above-described second embodiment, it is possible to improve the maintainability by configuring the drying unit so as to be forwardly drawable from the printing apparatus.

### Third Embodiment

### Configuration of Easy-To-Maintain Drying Unit 40

Next, an alternate configuration in which the maintenance of the above-described drying unit 40 is facilitated will be described. In the following description, the overall configuration of the printing apparatus, the configuration of the drying unit 40, and the like are the same as those of the first and second embodiments. Therefore, constituent elements that are the same as those of the first and second embodiments are denoted by the same reference numerals, and descriptions thereof have been omitted where appropriate.

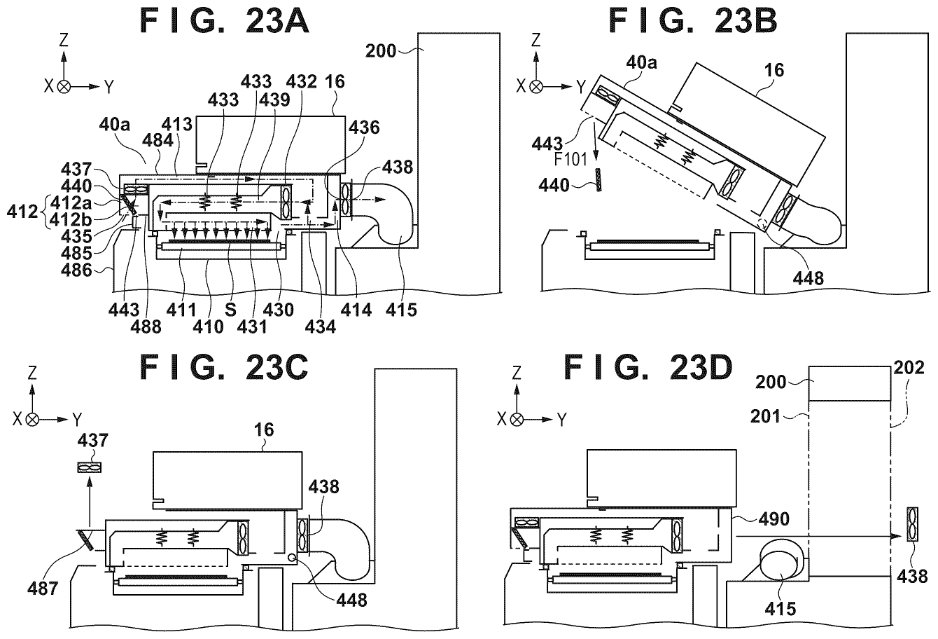

FIG. 23A shows a cross-sectional view of the drying unit 40. The first drying unit 40_a1 and the first drying unit 40_a2 have the same configuration except for the nozzle patterns (arrangements and hole shapes, etc.) of the airflow duct 431, and therefore will be collectively described as the drying unit 40. The dash-dot line in FIG. 23A indicates the airflow inside the drying unit 40.

The drying unit 40 communicates with outside air via the above-described ventilation port 435 in the −Y direction, which is the front side of the apparatus. Inside the drying unit 40, an intake space 412 is formed above the ventilation port 435. The intake space 412 is partitioned by the filter 440, and the air flows from an intake space 412a on the upstream side to an intake space 412b via the filter 440. By obliquely placing the filter 440, a filter having a large size than the size of the opening of the ventilation port 435 can be placed within the intake space 412. The filter 440 serves to prevent dust contained in outside air from flowing into the apparatus. A filter opening 443 is provided in the −Z direction of the filter 440, and the filter opening 443 provided in the cover holding plate 488 is exposed when a first front cover 485 is removed.

The air in the intake space 412b is sent into an intake path 413 by the intake fan 437. The intake path 413 is formed above the drying unit 40 from the −Y direction toward the +Y direction, and the air at ordinary temperatures flows therein. Accordingly, heat from the airflow space 430 and a heating space 439 is less likely to be conducted to a top cover 484 that is accessible from the user, and therefore a rise in temperature can be suppressed. Since a rise in temperature can also be suppressed in the ink feed device 16 installed above the drying unit 40, the inks stored in the ink feed device 16 are less likely to be adversely affected. As such, the intake path 413 is formed as an airflow path having a heat insulation function as a whole.

The intake path 413 and the blower 432 are connected to each other in the +Y direction of the drying unit 40. An airflow is sent into the heating space 439 by the blower 432. The heater 433 is disposed in the heating space 439, and the air that has passed through the heating space 439 is heated to a high temperature. The heating space 439 is a space extending continuously from the +Y direction to the −Y direction, and further communicates with the airflow duct 431 in the −Y direction. The airflow duct 431 faces the sheet S, and has a plurality of nozzle holes open therein in the sheet width direction of the sheet S (the Y direction). This allows the high-temperature airflow to be uniformly blown toward the sheet S, thus making it possible to accelerate the drying of the inks applied on the sheet S.

The airflow space 430 in which the high-temperature airflow is blown to the sheet S communicates with the circulation exhaust port 434 and the exhaust port 436. The gap between the airflow space 430 and the sheet support unit 410 including the sheet support roller 411 supporting the sheet S is sealed by a sponge material, and high-temperature warm air will not leak into the apparatus except for a sheet conveyance unit opening (not shown). The airflow that has passed through the circulation exhaust port 434 merges with the airflow in the intake path 413, and circulated again as a drying airflow by the blower 432.

On the other hand, the airflow that passed through without flowing into the circulation exhaust port 434 passes through an exhaust path 414 and discharged from the drying unit 40 by the exhaust port 436 and the exhaust fan 438. The exhaust fan 438 is connected to the exhaust duct 415 and merged with a similar exhaust duct connected in an electric casing 200 from another drying unit, and discharges the airflow to the outside of the apparatus from an opening (not shown) in the electric casing 200.

FIG. 23B is a cross-sectional view showing the drying unit 40 when the filter 440 is attached and detached.

The drying unit 40 and the ink feed device 16 stacked thereon opens at about 30° about the hinge portion 448 as a rotation center. The first front cover 485 has been removed, and the filter opening 443 is in an accessible state as described above. The filter 440 attached inside the drying unit 40 can be pulled out from the filter opening 443 in the direction indicated by arrow F101. In the case of returning the filter 440, the filter 440 can be set by causing the filter 440 to slide in a direction opposite to the direction indicated by the arrow F101. After completion of the attachment of the filter 440, the filter opening 443 is closed by attaching the first front cover 485 again, and therefore the filter 440 will not be accidentally removed. Accordingly, a maintenance work such as periodic cleaning performed on the surface of the filter 440, and periodic replacement of the filter 440 can be performed.

Next, a procedure for replacing the intake fan 437 will be described with reference to FIG. 23C. The intake fan 437 is an electric device that functions when current flows therethrough, and may be replaced when an unexpected failure has occurred. FIG. 23C is a cross-sectional view of the drying unit 40 when the intake fan 437 is replaced. In this drawing, after removal of the first front cover 485, the top cover 484 has been further removed.

As shown in FIGS. 23A to 23C, a portion of the top cover 484 that is located on the front side of the apparatus than the ink feed device 16 is separated, and the ink feed device 16 can be removed in that state. At the time of replacing the intake fan 437, the intake fan 437 is more easily accessible when the drying unit 40 is not open, and therefore the drying unit 40 is closed again about the hinge portion 448. In this state, the fixing of the intake fan 437 to the device holding plate 487 can be released through accessing from the +Z direction, and therefore the intake fan 437 can be replaced in the case of failure. The other electric devices attached to the device holding plate 487 can also be replaced in the same manner.

Next, a procedure for performing maintenance of the exhaust fan 438 will be described with reference to FIG. 23D. FIG. 23D is a cross-sectional view of the drying unit 40 when the exhaust fan 438 is replaced.

The electric casing 200 covering the drying unit 40 in the +Y direction is provided with a first opening 201 and a second opening 202 for accessing the exhaust fan 438. These openings are exposed to the outside by removing or opening a cover member of the electric casing 200. Components that are contained in the electric casing 200 are also moved so as not to interfere with access to the exhaust fan 438. The exhaust duct 415 is removed from the exhaust fan 438 and an exhaust unit frame 490. The exhaust duct 415 is formed in a hose shape and can be freely bent, and therefore is accommodated so as not to interfere with removal of the exhaust fan 438, as shown in FIG. 23D. This makes it possible to replace, from the +Y direction, an electric device disposed in the +Y direction in the drying unit 40, through the electric casing. The other electric devices attached to the exhaust unit frame 490 can also be replaced in the same manner.

As described thus far, according to the third embodiment, it is possible to increase the maintainability by enabling the drying unit to be opened and closed in the up-down direction relative to the printing apparatus.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), or the like) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-082896, filed May 21, 2024, which is hereby incorporated by reference herein in its entirety.

What is claimed is:

1. A printing apparatus configured to dry a liquid composition applied to a print medium while conveying the print medium between a plurality of casings, wherein
a blowing mechanism for blowing air to the print medium is disposed in at least one of the plurality of casings, and,
between a first casing in which a first blowing mechanism serving as the blowing mechanism is disposed and a second casing adjacent to the first casing, a connection member for connecting a blowing space in the first blowing mechanism of the first casing and a conveyance space in the second casing in which space the print medium is conveyed, thereby forming a closed space, is disposed.

2. The printing apparatus according to claim 1, wherein the blowing mechanism blows warm air to the print medium.

3. The printing apparatus according to claim 2, wherein the blowing mechanism includes a heating device for heating air.

4. The printing apparatus according to claim 1, wherein the blowing mechanism blows cool air to the print medium.

5. The printing apparatus according to claim 1, wherein the connection member is attachable to and removable from the casings.

6. The printing apparatus according to claim 1, wherein the connection member includes an upper member and a lower member, and the upper member is removable from the lower member.

7. The printing apparatus according to claim 1, wherein the blowing mechanism is supported so as to be openable and closable with respect to the casing using a rotational shaft as a support point, and is switchable between a state in which the blowing space is formed, and a state in which the blowing space is opened.

8. The printing apparatus according to claim 1, wherein a second blowing mechanism is disposed in the conveyance space in the second casing.

9. The printing apparatus according to claim 1, wherein a blowing unit including the blowing mechanism is drawable from the casing of the printing apparatus.

10. The printing apparatus according to claim 9, wherein a cover that is openable and closable while holding a backup member for maintaining a distance between the blowing unit and the print medium is disposed above the blowing unit.

11. The printing apparatus according to claim 10, wherein the backup member is a roller.

12. The printing apparatus according to claim 10, wherein the backup member is a platen.

13. The printing apparatus according to claim 9, wherein the blowing unit is configured to be drawable from a body of the printing apparatus after a wiring connected to the blowing unit has been disconnected.

14. The printing apparatus according to claim 9, further comprising an exhaust path connected to the blowing unit and configured to discharge air in the blowing unit to outside, wherein the exhaust path is connected to the blowing unit in a state in which the blowing unit is accommodated in the casing, and is spaced apart from the blowing unit in a state in which the blowing unit is drawn from the casing.

15. The printing apparatus according to claim 9, wherein, in a state in which the blowing unit is drawn from the casing, a device disposed on a back side of the blowing unit is removable.

16. The printing apparatus according to claim 15, further comprising an openable and closable cover unit, wherein the device is removable from a space between the cover unit and the drawn blowing unit.

17. The printing apparatus according to claim 15, wherein a sealing member configured to be compressed between the device and the blowing unit is disposed in the device, and the printing apparatus further comprises a restricting member configured to restrict movement of the device such that the device moves in a direction opposite to a direction of compression of the sealing member, in a case where the device is removed.

18. The printing apparatus according to claim 15, wherein the device is a fan of the blowing unit.

19. The printing apparatus according to claim 15, wherein the device is a temperature sensor.
